(19) United States
(12) Patent Application Publication
(10) Pub. No.: US 2023/0161002 A1
(43) Pub. Date: May 25, 2023

(54) TIME-OF-FLIGHT SENSORS, METHODS, AND NON-TRANSITORY COMPUTER-READABLE MEDIA WITH ERROR CORRECTING CODE

(71) Applicant: Sony Semiconductor Solutions Corporation, Kanagawa (JP)

(72) Inventors: Ping Wah Wong, Sunnyvale, CA (US); Kevin Chan, San Jose, CA (US); Takuro Kamiya, (US)

(21) Appl. No.: 17/885,863

(22) Filed: Aug. 11, 2022

Related U.S. Application Data
(63) Continuation-in-part of application No. 17/534,974, filed on Nov. 24, 2021.

(51) Int. Cl. G01S 7/48; G01S 17/08; G01S 7/497

(52) U.S. Cl. CPC G01S 7/4808; G01S 17/08; G01S 7/497

(57) ABSTRACT

Time-of-Flight (ToF) sensors, methods, and non-transitory computer-readable media. In one example of the present disclosure, a ToF sensor includes an array of pixels and processing circuitry. The processing circuitry configured to generate a plurality of ToF exposure control signals that control at least one pixel of the array of pixels to generate a plurality of ToF pixel signals, generate a plurality of error correcting code (ECC) exposure control signals that control the at least one pixel to generate a plurality of ECC pixel signals, and determine a distance from an object based on the plurality of ToF pixel signals and the plurality of ECC pixel signals by determining a region code from the plurality of ToF pixel signals and the plurality of ECC pixel signals, and calculating the distance based on the plurality of ToF pixel signals, the plurality of ECC pixel signals, and information from the region code.

### CROSS-REFERENCE TO RELATED APPLICATION

This application is a continuation-in-part application that claims priority to, and the benefit of, U.S. patent application Ser. No. 17/534,974, filed on Nov. 24, 2021, the entire contents of which is incorporated herein by reference.

### BACKGROUND OF THE INVENTION

### 1. Field of the Invention

This application relates to Time-of-Flight (ToF) sensors, methods, and non-transitory computer-readable media with an error correcting code (ECC).

### 2. Description of Related Art

Time-of-flight (ToF) is a technique used in rebuilding three-dimensional (3D) images. The ToF technique includes calculating the distance between a light source and an object by measuring the time for light to travel from the light source to the object and return to a light-detection sensor, where the light source and the light-detection sensor are located in the same device.

Conventionally, an infrared light-emitting diode (LED) is used as the light source to ensure high immunity with respect to ambient light. The information obtained from the light that is reflected by the object may be used to calculate a distance between the object and the light-detection sensor, and the distance may be used to reconstruct the 3D images. The 3D images that are reconstructed may then be used in gesture and motion detection. Gesture and motion detection is being used in different applications including automotive, drone, and robotics, which require more accurate and faster acquisition of the information used to calculate the distance between the object and the light-detection source in order to decrease the amount of time necessary to reconstruct the 3D images.

Image sensing devices typically include an image sensor, an array of pixel circuits, signal processing circuitry and associated control circuitry. Within the image sensor itself, charge is collected in a photoelectric conversion device of the pixel circuit as a result of impinging light. Subsequently, the charge in a given pixel circuit is read out as an analog signal, and the analog signal is converted to digital form by an analog-to-digital converter (ADC).

However, there are many noise sources that affect an output of the ToF sensor. For example, some noise sources include shot noise in the photon, KTC noise in the circuit, system noise and fixed pattern noise from pixel and circuit design, and quantization noise in the ADC. All of these noise sources in the pixel data will contribute to depth noise.

### BRIEF SUMMARY OF THE INVENTION

Consider a Time-of-Flight (ToF) decoding method that includes a region decoder plus distance calculation after a region has been decoded. Low signal to noise ratio (e.g., for long distance measurement) causes an incorrect region code decision, which causes a very large error in decoded distance. Accordingly, there exists a need for a ToF sensor that do not suffer from these deficiencies.

As described in greater detail below, a ToF sensor incorporates additional pixel signals to generate an error correcting code (ECC) with the ToF pixel signals. The ECC significantly reduces the probability of a region code decision error, and consequently, significantly increases accuracy in a decoded distance.

Various aspects of the present disclosure relate to ToF sensors, methods, and non-transitory computer-readable media. In one aspect of the present disclosure, a ToF sensor includes an array of pixels and processing circuitry. The processing circuitry configured to generate a plurality of ToF exposure control signals that control at least one pixel of the array of pixels to generate a plurality of ToF pixel signals, generate a plurality of error correcting code (ECC) exposure control signals that control the at least one pixel to generate a plurality of ECC pixel signals, and determine a distance from an object based on the plurality of ToF pixel signals and the plurality of ECC pixel signals. To determine the distance from the object based on the plurality of ToF pixel signals and the plurality of ECC pixel signals, the processing circuitry is further configured to determine a region code from the plurality of ToF pixel signals and the plurality of ECC pixel signals, and calculate the distance based on the plurality of ToF pixel signals, the plurality of ECC pixel signals, and the region code.

Another aspect of the present disclosure is a method. The method includes generating, with processing circuitry, a plurality of ToF exposure control signals that control at least one pixel of an array of pixels to generate a plurality of ToF pixel signals. The method includes generating, with the processing circuitry, a plurality of error correcting code (ECC) exposure control signals that control the at least one pixel to generate a plurality of ECC pixel signals. The method also includes determining, with the processing circuitry, a distance from an object based on the plurality of ToF pixel signals and the plurality of ECC pixel signals by determining a region code from the plurality of ToF pixel signals and the plurality of ECC pixel signals, and calculating the distance based on the plurality of ToF pixel signals, the plurality of ECC pixel signals, and the region code.

In yet another aspect of the present disclosure, a non-transitory computer-readable medium comprises instructions that, when executed by an electronic processor, cause the electronic processor to perform a set of operations. The set of operations includes generating a plurality of ToF exposure control signals that control at least one pixel of an array of pixels to generate a plurality of ToF pixel signals. The set of operations includes generating a plurality of error correcting code (ECC) exposure control signals that control the at least one pixel to generate a plurality of ECC pixel signals. The set of operations also includes determining a distance from an object based on the plurality of ToF pixel signals and the plurality of ECC pixel signals by determining a region code from the plurality of ToF pixel signals and the plurality of ECC pixel signals, and calculating the distance based on the plurality of ToF pixel signals, the plurality of ECC pixel signals, and the region code.

This disclosure may be embodied in various forms, including hardware or circuits controlled by computer-implemented methods, computer program products, computer systems and networks, user interfaces, and application programming interfaces; as well as hardware-implemented methods, signal processing circuits, image sensor circuits, application specific integrated circuits, field programmable gate arrays, digital signal processors, and other suitable forms. The foregoing summary is intended solely to give a general idea of various aspects of the present disclosure, and does not limit the scope of the present disclosure.

### BRIEF DESCRIPTION OF THE DRAWINGS

These and other more detailed and specific features of various embodiments are more fully disclosed in the following description, reference being had to the accompanying drawings, in which:

FIG. 1 is a diagram that illustrates an example Time-of-Flight (ToF) imaging environment, in accordance with various aspects of the present disclosure.

FIG. 2 is a diagram illustrating processes performed by a controller.

FIG. 3 is a diagram illustrating an error in a region decision.

FIG. 4 is a diagram illustrating impact of noise on bit error for a region code.

FIG. 5 is a chart illustrating a probability of a bit error versus a region number.

FIG. 6 is a diagram illustrating different example bit errors in a region code.

FIG. 7 is a diagram illustrating the image sensor and the ToF/ECC decoder of FIG. 1, in accordance with various aspects of the present disclosure.

FIG. 8 is a diagram illustrating four different examples of ECC.

FIG. 9 is a diagram illustrating a probability of a correct region decision across the four different examples of ECC of FIG. 8 and no ECC, in accordance with various aspects of the present disclosure.

FIG. 10 is a diagram illustrating a probability of a correct region decision with invalidity across the four different examples of ECC of FIG. 8 and no ECC, in accordance with various aspects of the present disclosure.

FIG. 11 is a diagram illustrating a performance of Hamming (8,4) code in the ToF sensor, in accordance with various aspects of the present disclosure.

FIG. 12 is a diagram illustrating exposure control signals with respect to Ham4 and the Hamming (8,4) code in the ToF sensor, in accordance with various aspects of the present disclosure.

FIG. 13 is a diagram illustrating exposure control signals with respect to Gray4 and the Hamming (8,4) code in the ToF sensor, in accordance with various aspects of the present disclosure.

FIG. 14 is a flowchart illustrating a process for thresholding pixel signals to produce ToF and ECC bits, in accordance with various aspects of the present disclosure.

FIG. 15 is a diagram illustrating an array of codewords corresponding to Ham4 ECC including region code bits and ECC bits, in accordance with various aspects of the present disclosure.

FIG. 16 is a diagram illustrating an array of codewords corresponding to Gray4 ECC which include region code bits and ECC bits, in accordance with various aspects of the present disclosure.

FIG. 17 is a flow diagram illustrating an ECC decoding process for determining a region code, in accordance with various aspects of the present disclosure.

FIG. 18 is a chart illustrating approximate decoding error based on a particular bit error.

FIG. 19 is a chart illustrating a ToF sensor signal level across decoding regions for two different exposure times.

FIG. 20 is a chart illustrating a bit error probability of each decoding region for two different exposure times.

FIG. 21 is a chart illustrating an average error due to incorrect region code with Ham4 ECC bits, in accordance with various aspects of the present disclosure.

FIG. 22 is a chart illustrating a standard deviation error due to incorrect region code with Ham4 ECC bits, in accordance with various aspects of the present disclosure.

FIG. 23 is a chart illustrating an average error due to incorrect region code with Gray4 ECC bits, in accordance with various aspects of the present disclosure.

FIG. 24 is a chart illustrating a standard deviation error due to incorrect region code with Gray4 ECC bits, in accordance with various aspects of the present disclosure.

FIG. 25 is a diagram illustrating a second example of a controller with a ToF/ECC decoder, in accordance with various aspects of the present disclosure.

FIG. 26 is a chart illustrating non-half shifted regions and corresponds to FIG. 3, in accordance with various aspects of the present disclosure.

FIG. 27 is a chart illustrating half shifted regions, in accordance with various aspects of the present disclosure.

FIG. 28 is a table of equivalent signals for half shifted regions, in accordance with various aspects of the present disclosure.

FIG. 29 is a chart illustrating highlighted sections with respect to the equivalent signals for the half shifted regions, in accordance with various aspects of the present disclosure.

FIG. 30 is a flowchart illustrating an example process for determining an object distance, in accordance with various aspects of the present disclosure.

FIG. 31 is a chart illustrating two of a plurality of ToF pixel signals changing in each half shifted region, in accordance with various aspects of the present disclosure.

FIG. 32 is a table illustrating first example calculations to determine a lower half or a upper half in a half shifted region, in accordance with various aspects of the present disclosure.

FIG. 33 is a chart illustrating a combined pixel signal from the first example calculations of FIG. 32 based on the plurality of ToF pixels of FIG. 31, in accordance with various aspects of the present disclosure.

FIG. 34 is a chart illustrating a second combined pixel signal from the first example calculations of FIG. 32 based on the plurality of ToF pixels of FIG. 31, in accordance with various aspects of the present disclosure.

FIG. 35 is a table illustrating second example calculations to determine a lower half or a upper half in a half shifted region, in accordance with various aspects of the present disclosure.

FIG. 36 is a chart illustrating first and second combined pixel signals from the first example calculations of FIG. 32 and the second example calculations of FIG. 35, respectively, and based on the plurality of ToF pixels of FIG. 31, in accordance with various aspects of the present disclosure.

FIG. 37 is a diagram illustrating third example calculations to determine a lower half or a upper half in a half shifted region, in accordance with various aspects of the present disclosure.

FIG. 38 is a diagram illustrating a comparison between the decoding method for ECC ToF shown in FIG. 30, the decoding method for ECC ToF using the non-averaged pixel signals, and the decoding method in a ToF system with no ECC, in accordance with various aspects of the present disclosure.

### DETAILED DESCRIPTION

In the following description, numerous details are set forth, such as flowcharts, equations, and circuit configurations. It will be readily apparent to one skilled in the art that these specific details are exemplary and do not to limit the scope of this application.

In this manner, the present disclosure provides improvements in the technical field of time-of-flight sensors, as well as in the related technical fields of image sensing and image processing.

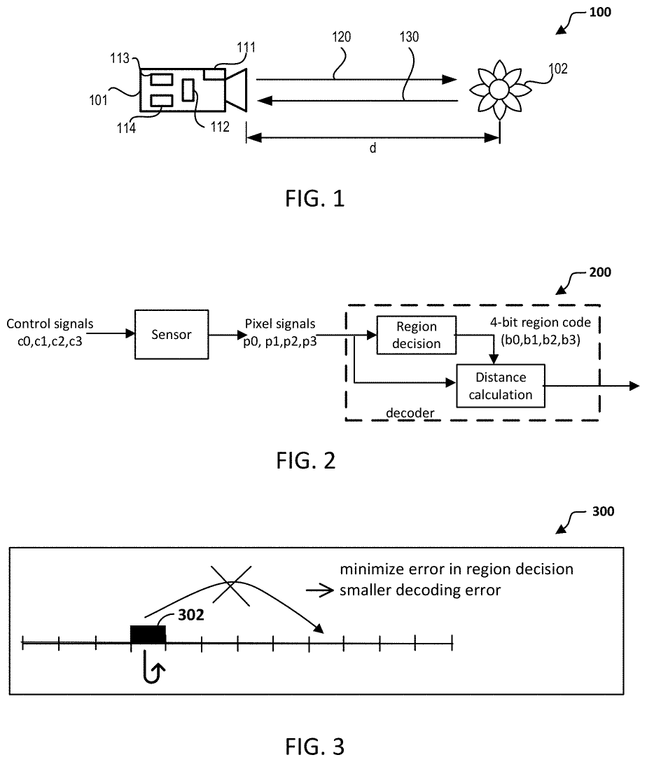

FIG. 1 is a diagram illustrating an example of a time-of-flight (ToF) imaging environment 100, according to various aspects of the present disclosure. In the example of FIG. 1, the ToF imaging environment 100 includes a ToF imaging system 101 that is configured to image an object 102 located a distance d away. The ToF imaging system 101 includes a light generator 111 configured to generate an emitted light wave 120 toward the object 102 and an image sensor 112 configured to receive a reflected light wave 130 from the object 102. The emitted light wave 120 may have a periodic waveform. The image sensor 112 may be any device capable of converting incident radiation into signals. For example, the image sensor may be a Complementary Metal-Oxide Semiconductor (CMOS) Image Sensor (CIS), a Charge-Coupled Device (CCD), or other suitable image sensor. The ToF imaging system 101 may further include distance determination circuitry such as a controller 113 (for example, a microprocessor or other suitable processing device) and a memory 114, which may operate to perform one or more examples of time-of-flight processing as described below. The light generator 111, the image sensor 112, the controller 113, and the memory 114 may be implemented on the same semiconductor piece, or they may be implemented separately and are communicatively connected to each other via one or more communication buses.

The light generator 111 may be, for example, a light emitting diode (LED), a laser diode, or any other light generating device or combination of devices, and the light waveform may be controlled by the controller 113. The light generator may operate in the infrared range so as to reduce interference from the visible spectrum of light, although any wavelength range perceivable by the image sensor 112 may be utilized.

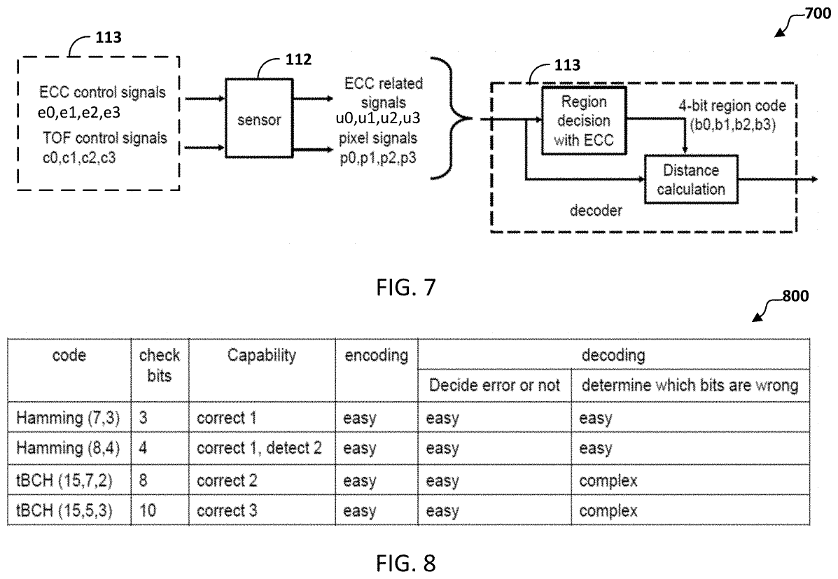

In some examples, the controller 113 includes an error correcting code (ECC) generator, a ToF signal generator, and an ToF/ECC decoder. The ECC generator generates ECC pixel exposure control signals. The ToF signal generator generates ToF pixel exposure control signals. The ToF/ECC decoder decodes a region code from ToF pixel signals based on the ToF pixel exposure control signals together with ECC pixel signals based on the ECC pixel exposure control signals. In a ToF system, even though an object may be at a distance within the maximum range dₘₐₓ of the ToF design, the signal to noise ratio corresponding to objects near the high end of the maximum range may be too low so that the object distance cannot be reliably calculated from the signals received by the sensor. As a result, only a fraction of the maximum range dₘₐₓ may be actually usable. The ECC pixel signals increase a probability that the region code decoded from the ToF pixel signals is a correct region code, which increases distance calculation accuracy and extends operating range of the ToF imaging system 101. The controller 113 is described in greater detail in FIGS. 7-24.

FIG. 2 is a diagram illustrating a process 200 performed by a comparative ToF imaging system. As illustrated in FIG. 2, the process 200 includes a ToF image sensor receiving ToF exposure control signals c0, c1, c2, and c3 from a controller and outputting the ToF pixel signals p0, p1, p2, and p3. The process 200 includes a decoder of the controller receiving the pixel signals p0, p1, p2, and p3 and making a region decision from the pixel signals p0, p1, p2, and p3 by outputting a four-bit region code b0, b1, b2, and b3. The process 200 also includes the decoder performing a distance calculation of an object based on the pixel signals p0, p1, p2, and p3 and the four-bit region code b0, b1, b2, and b3.

FIG. 3 is a diagram illustrating an error 300 in a region decision. As illustrated in FIG. 3, an object 302 may be located in the fourth region (as highlighted). However, an error 300 in one or more bits of the four-bit region code b0, b1, b2, and b3 may result in the region code incorrectly indicating that the object is in the ninth region. The incorrect region code may result in a significant error in the calculated distance. Moreover, the error 300 in the one or more bits of the four-bit region code b0, b1, b2, and b3 may be a result from noise in the pixel signals.

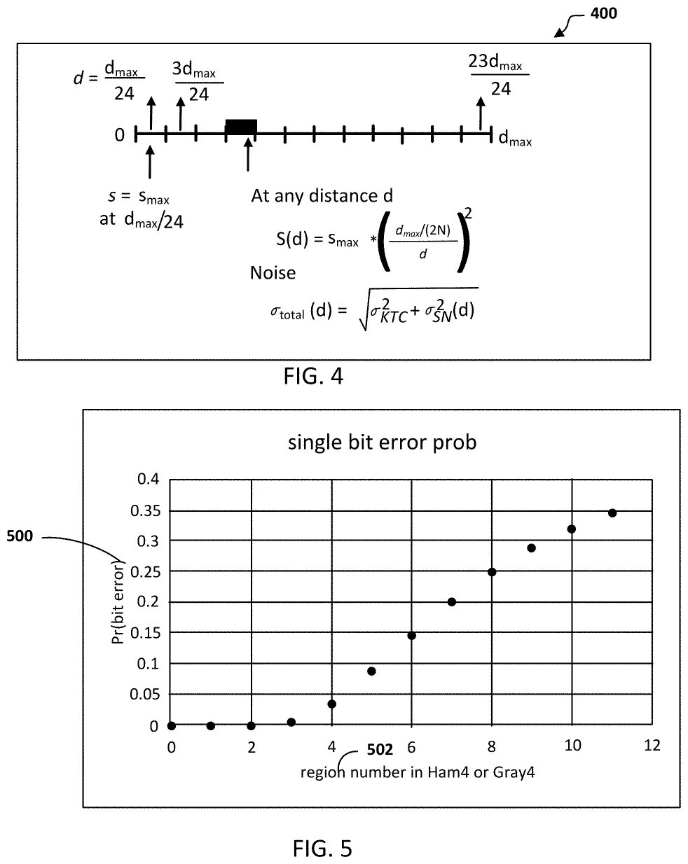

FIG. 4 is a diagram illustrating impact 400 of noise on bit error for a region code. As illustrated in FIG. 4, there are 12 regions between zero and the maximum operating distance (dₘₐₓ). Considering the midpoint for each region, then the distance is equal to Expression (1).

$$d = \frac{( 2 x + 1 ) \times {d}_{max}}{2 \times N} \qquad ( 1 )$$

In Expression (1), x is equal to the region index from 0 to 11, dₘₐₓ is equal to the maximum operating distance, and N is the number of regions between zero and dₘₐₓ. In the above example, N is equal to 12.

As illustrated in FIG. 4, the maximum signal (sₘₐₓ) among the mid points of the regions is at dₘₐₓ/(2N), which is the first region. In this consideration, the signals at distances closer to (i.e., smaller than) the point dₘₐₓ/(2N) are ignored for two reasons. First, objects at very close distance will cause saturation to the pixel signals. Second, objects at very close distance may exceed the capability of the camera lens which may not be able to focus. At any distance d, the signal is equal to Expression (2) below.

$$s ( d ) = {s}_{max} * {( \frac{{d}_{max} / ( 2 N )}{d} )}^{2} \qquad ( 2 )$$

In Expression (2), sₘₐₓ is equal to the maximum signal strength, dₘₐₓ is equal to the maximum operating distance, and N is the total number of regions between zero and dₘₐₓ. In the above example, N is equal to 12.

However, the signal is also subject to noise. At any distance d, the noise is equal to Expression (3) below.

σₜₒₜₐₗ(d)=\sqrt{σ_{KTC}²+σ_{SN}²(d)} (3)

The KTC noise is sampling noise that does not depend on distance. The shot noise (SN) is signal noise that depends on the signal level, and consequently, depends on the distance because the signal level depends on the distance.

A bit error in the region code occurs when the magnitude of the noise sample is higher than s(d)/2. FIG. 5 is a chart illustrating a probability of a single bit error 500 versus a region number 502. As illustrated in FIG. 5, the probability of a single bit error 500 is approximately 0% in regions 0-2 and rises to a probability of 10% by region 5. The probability of the single bit error 500 further rises to 25% by region 8 and 35% at region 11.

However, the region code is a four-bit code and not a single bit code. A correct region code requires all bits to be correct. Therefore, the overall probability that the region code is incorrect is the probability that includes at least one-bit error, which is much greater than the probability of the single bit error 500.

For example, each bit in region 8 has a 25% chance of a bit error. Therefore, the region code of region 8 has a much higher cumulative chance of a bit error than just 25%, for example, greater than 50%. Consequently, the region code of region 8 may be assumed to have a high probability of error due to the higher cumulative chance of a bit error. In other words, the maximum operating distance to have an acceptable probability of error is not actually dₘₐₓ, but a much shorter distance than dₘₐₓ because of the high likelihood that the region code will have a bit error at or above the fifth region.

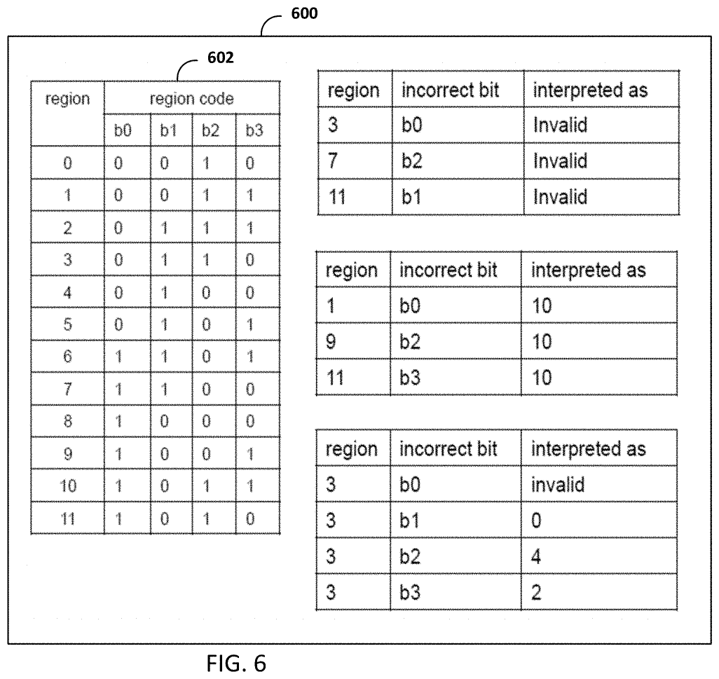

FIG. 6 is a diagram illustrating different example bit errors in a region code. As illustrated in FIG. 6, the diagram 600 includes regions 0-11 that correspond to a specific region code in a look-up table 602. For example, region 0 corresponds to region b0, b1, b2, and b3 equal to 0, 0, 1, 0, respectively. Region 1 corresponds to region b0, b1, b2, and b3 equal to 0, 0, 1, 1, respectively. Region 2 corresponds to region b0, b1, b2, and b3 equal to 0, 1, 1, 1, respectively. Region 3 corresponds to region b0, b1, b2, and b3 equal to 0, 1, 1, 0, respectively. Region 4 corresponds to region b0, b1, b2, and b3 equal to 0, 1, 0, 0, respectively. Region 5 corresponds to region b0, b1, b2, and b3 equal to 0, 1, 0, 1, respectively. Region 6 corresponds to region b0, b1, b2, and b3 equal to 1, 1, 0, 1, respectively. Region 7 corresponds to region b0, b1, b2, and b3 equal to 1, 1, 0, 0, respectively. Region 8 corresponds to region b0, b1, b2, and b3 equal to 1, 0, 0, 0, respectively. Region 9 corresponds to region b0, b1, b2, and b3 equal to 1, 0, 0, 1, respectively. Region 10 corresponds to region b0, b1, b2, and b3 equal to 1, 0, 1, 1, respectively. Region 11 corresponds to region b0, b1, b2, and b3 equal to 1, 0, 1, 0, respectively.

However, regions 0-11 may correspond to different region codes than the region codes illustrated in FIG. 6. The region codes of FIG. 6 are an example for ease of understanding and the present disclosure is not limited to the examples provided in FIG. 6.

Additionally, as illustrated in FIG. 6, an incorrect bit will result in the region being interpreted in an incorrect region or deemed “invalid.” To be deemed “invalid,” a region code must have an incorrect bit that changes the correct region code to a region code that does not exist in the look-up table 602. For example, when region 3 has an incorrect bit at bit b0, then the resulting region code 1110 is “invalid” because 1110 is not present in the look-up table 602. The same invalidity applies to regions 7 and 11 and incorrect bits at bits b2 and b1, respectively.

With respect to incorrect regions, a region code will have an incorrect bit that changes the correct region code to a region code that is different from the correct region code. For example, when region 1 has an incorrect bit at bit b0, then the resulting region code 1011 is “incorrect” because 1011 corresponds to region 10. The same error applies to regions 9 and 11 and incorrect bits at bits b2 and b3, respectively.

Lastly, a single region may be interpreted four different ways because the single region includes four different bits that may be incorrect. For example, when region 3 (with region code 0110) has an incorrect bit at bit b0, then the resulting region code 1110 is “invalid” because 1110 is not present in the look-up table 602. Alternatively, when region 3 has an incorrect bit at bits b1, b2, or b3, then the resulting region codes 0010, 0100, and 0111 are “incorrect” because these region codes correspond to regions 0, 4, and 2, respectively, instead of the correct region, i.e., region 3.

FIG. 7 is a flowchart illustrating a process 700 performed by the ToF imaging system 101, in accordance with various aspects of the present disclosure. As illustrated in FIG. 7, the process 700 includes a ToF image sensor (e.g., the image sensor 112 of FIG. 1) receiving ECC control signals e0, e1, e2, and e3 and ToF exposure control signals c0, c1, c2, and c3 from a controller (e.g., the controller 113 of FIG. 1) and outputting ToF pixel signals p0, p1, p2, and p3 and ECC pixel signals u0, u1, u2, and u3.

The process 700 includes a decoder of the controller (e.g., the ECC/ToF decoder of the controller 113) receiving the ToF pixel signals p0, p1, p2, and p3 and the ECC pixel signals u0, u1, u2, and u3 and makes a region decision from the pixel signals p0, p1, p2, and p3 and the ECC pixel signals u0, u1, u2, and u3 by outputting a four bit region code b0, b1, b2, and b3. The process 700 also includes the decoder performing a distance calculation of an object (e.g., the object 102) based on the ToF pixel signals p0, p1, p2, and p3, the ECC pixel signals u0, u1, u2, and u3, and the four bit region code b0, b1, b2, and b3.

FIG. 8 is a chart illustrating four different examples of ECC. As illustrated in FIG. 8, the chart 800 includes four different ECCs: Hamming (7,3), Hamming (8,4), tBCH (15,7,2), and tBCH (15,5,3). Hamming (7,3) uses three check bits. Hamming (8,4) uses four check bits. tBCH (15,7,2) uses eight check bits. tBCH (15,5,3) uses ten check bits.

Hamming (7,3) has the capability of correcting one incorrect bit. Hamming (8,4) has the capability of correcting one incorrect bit and detecting two incorrect bits. tBCH (15,7,2) has the capability of correcting two incorrect bits. tBCH (15,5,3) has the capability of correcting three incorrect bits.

All four ECCs are easy to encode an easy to decide on whether an error exists with a particular bit. However, tBCH (15,7,2) and tBCH (15,5,3) are complex to determine which bits are incorrect, whereas Hamming (7,3) and Hamming (8,4) are easier than tBCH (15,7,2) and tBCH (15,5,3) to determine the incorrect bit.

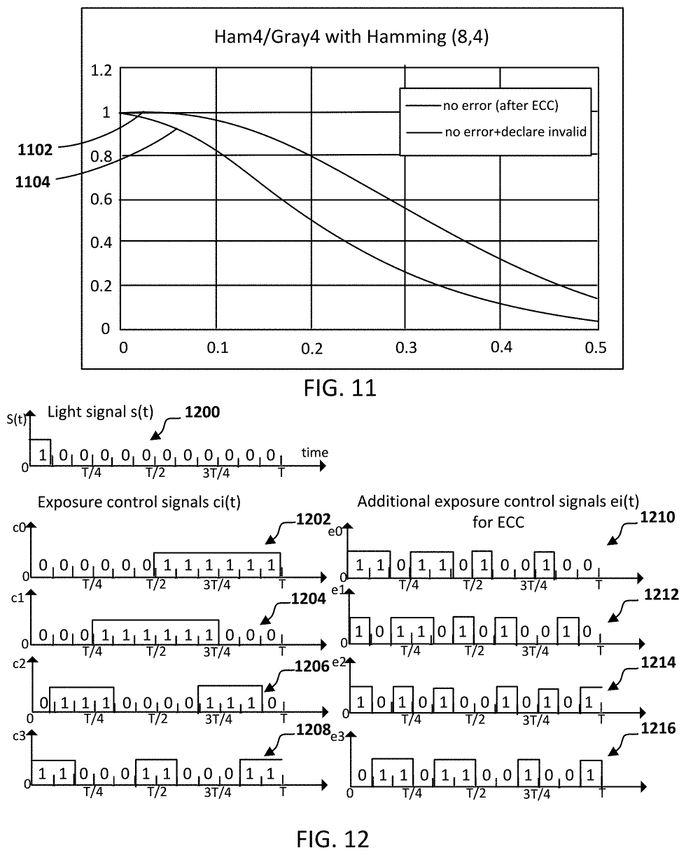

The present disclosure is not limited to these four ECCs and any ECC may be used. Of the four ECCs, tBCH (15,5,3) has the best performance. However, tBCH (15,5,3) also requires fifteen signals, which results in a big frame delay, and a complex decoder. Therefore, Hamming (8,4) is selected for discussion with respect to FIGS. 11-24 because Hamming (8,4) has excellent performance while requiring eight signals and a less complex decoder than tBCH (15,5,3).

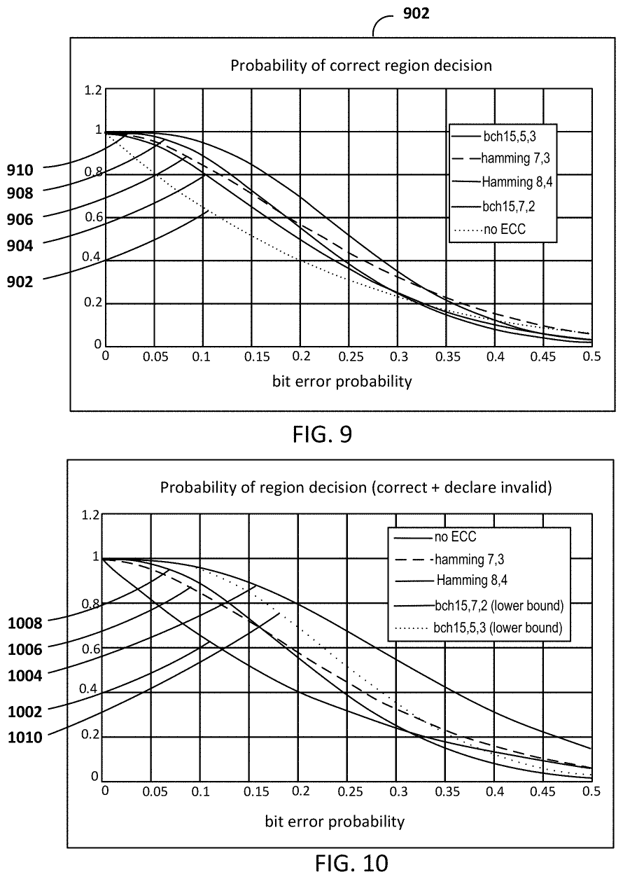

FIG. 9 is a diagram illustrating a probability of a correct region decision across the four different examples of ECC of FIG. 8 and no ECC, in accordance with various aspects of the present disclosure. As illustrated in FIG. 9, at a bit error probability of 5%, the probability of a correct region decision is approximately 80% for no ECC 902, approximately 95% for Hamming (8,4) 904, approximately 96% for Hamming (7,3) 906, approximately 98% for tBCH (15,7,2) 908, and approximately 99% for tBCH (15,5,3) 910.

Further, as illustrated in FIG. 9, at a bit error probability of 15%, the probability of a correct region decision is approximately 50% for no ECC 902, approximately 65% for Hamming (8,4) 904, approximately 70% for Hamming (7,3) 906, approximately 73% for tBCH (15,7,2) 908, and approximately 85% for tBCH (15,5,3) 910.

Additionally, as illustrated in FIG. 9, at a bit error probability of 30%, the probability of a correct region decision is approximately 25% for no ECC 902, approximately 28% for Hamming (8,4) 904, approximately 28% for tBCH (15,7,2) 908, approximately 35% for Hamming (7,3) 906, and approximately 38% for tBCH (15,5,3) 910.

Lastly, as illustrated in FIG. 9, at a bit error probability of 45%, the probability of a correct region decision is approximately 10% for no ECC 902, approximately 7% for Hamming (8,4) 904, approximately 5% for tBCH (15,7,2) 908, approximately 12% for Hamming (7,3), and approximately 7% for tBCH (15,5,3) 910.

FIG. 10 is a diagram illustrating a probability of a correct region decision and declare invalidity across the four different examples of ECC of FIG. 8 and no ECC, in accordance with various aspects of the present disclosure. As illustrated in FIG. 10, at a bit error probability of 5%, the probability of a correct region decision and declare invalidity is approximately 80% for no ECC 1002, approximately 99% for Hamming (8,4) 1004, approximately 96% for Hamming (7,3) 1006, approximately 98% for tBCH (15,7,2) 1008, and approximately 99% for tBCH (15,5,3) 1010.

Further, as illustrated in FIG. 10, at a bit error probability of 15%, the probability of a correct region decision and declare invalidity is approximately 50% for no ECC 1002, approximately 90% for Hamming (8,4) 1004, approximately 73% for Hamming (7,3) 1006, approximately 75% for tBCH (15,7,2) 1008, and approximately 88% for tBCH (15,5,3) 1010.

Additionally, as illustrated in FIG. 10, at a bit error probability of 30%, the probability of a correct region decision and declare invalidity is approximately 23% for no ECC 1002, approximately 55% for Hamming (8,4) 1004, approximately 25% for tBCH (15,7,2) 1008, approximately 35% for Hamming (7,3) 1006, and approximately 38% for tBCH (15,5,3) 1010.

Lastly, as illustrated in FIG. 10, at a bit error probability of 45%, the probability of a correct region decision and declare invalidity is approximately 10% for no ECC 1002, approximately 22% for Hamming (8,4) 1004, approximately 5% for tBCH (15,7,2) 1008, approximately 12% for Hamming (7,3) 1006, and approximately 7% for tBCH (15,5,3) 1010.

FIG. 11 is a diagram illustrating a performance of Hamming (8,4) in the ToF sensor 112, in accordance with various aspects of the present disclosure. Hamming (8,4) requires eight pixel signals per pixel. Hamming (8,4) may also correct one-bit error and may detect two bit errors. Hamming (8,4) does not handle three or more bit errors.

As illustrated in FIG. 11, at a bit error probability of 5%, the probability of a correct region decision 1102 is approximately 96% and the probability of a correct region decision and declare invalidity 1104 is approximately 99%. Further, as illustrated in FIG. 11, at a bit error probability of 15%, the probability of a correct region decision is approximately 68% and the probability of a correct region decision and declare invalidity is approximately 90%.

Additionally, as illustrated in FIG. 11, at a bit error probability of 30%, the probability of a correct region decision is approximately 25% and the probability of a correct region decision and declare invalidity is approximately 55%. Lastly, as illustrated in FIG. 11, at a bit error probability of 45%, the probability of a correct region decision is approximately 7% and the probability of a correct region decision and declare invalidity is approximately 21%.

FIG. 12 is a diagram illustrating exposure control signals with respect to Ham4 and the Hamming (8,4) code in the ToF sensor, in accordance with various aspects of the present disclosure. As illustrated in FIG. 12, the exposure control signals include a first set of exposure control signals 1202-1208 and a second set of exposure control signals 1210-1216 relative to a light signal 1200. The first set of exposure control signals 1202-1208 are ToF exposure control signals (e.g., c0, c1, c2, and c3) that control a given pixel to generate ToF pixel signals (e.g., p0, p1, p2, and p3). The second set of exposure control signals 1210-1216 are ECC exposure control signals (e.g., e0, e1, e2, and e3) that control a given pixel to generate ECC pixel signals (e.g., u0, u1, u2, and u3).

The light signal 1200 is a light emitted by a light generator (e.g. the light generator 111). The light signal 1200 is high during the first 1/12 of the period T. The light signal 1200 when divided into twelve durations over period T may be represented by a bit pattern corresponding to 100000000000. FIG. 12 shows one complete cycle of the exposure control signal 1202-1216 and the light signal 1200. In a ToF system these signals are repeated continuously according to the cycle time T.

The exposure control signal 1202 is a first exposure control signal for the given pixel. The exposure control signal 1202 is high during the second half of the period T. The exposure control signal 1202 when divided into twelve durations over period T corresponds to 000000111111.

The exposure control signal 1204 is a second exposure control signal for the given pixel. The exposure control signal 1204 is high during the middle of the period T. The exposure control signal 1204 when divided into twelve durations over period T corresponds to 000111111000.

The exposure control signal 1206 is a third exposure control signal for the given pixel. The exposure control signal 1206 is high during two distinct portions of the period T. The exposure control signal 1206 when divided into twelve durations over period T corresponds to 011100001110.

The exposure control signal 1208 is a fourth exposure control signal for the given pixel. The exposure control signal 1208 as shown is high during three distinct portions of the period T. Since the signals are periodic and repeats with the same pattern after the initial period, it can be observed that the third high period in 1208 in one cycle will join with the first high period of 1208 in the following cycle. Hence, the signal 1208 is high during two distinct portions of the period T. The exposure control signal 1208 when divided into twelve durations over period T corresponds to 110001100011.

The exposure control signal 1210 is a fifth exposure control signal for the given pixel. The exposure control signal 1210 is high during four distinct portions of the period T. The exposure control signal 1210 when divided into twelve durations over period T corresponds to 110110100100.

The exposure control signal 1212 is a sixth exposure control signal for the given pixel. The exposure control signal 1212 is high during five distinct portions of the period T. The exposure control signal 1212 when divided into twelve durations over period T corresponds to 101101010010.

The exposure control signal 1214 is a seventh exposure control signal for the given pixel. The exposure control signal 1214 as shown is high during six distinct portions of the period T. Since the signals are periodic and repeats with the same pattern after the initial period, it can be observed that the sixth high period in 1214 in one cycle will join with the first high period of 1214 in the following cycle. Hence, the signal 1214 is high during five distinct portions of the period T. The exposure control signal 1214 when divided into twelve durations over period T corresponds to 101010010101.

Lastly, the exposure control signal 1216 is an eighth exposure control signal for the given pixel. The exposure control signal 1216 is high during four distinct portions of the period T. The exposure control signal 1216 when divided into twelve durations over period T corresponds to 011011001001.

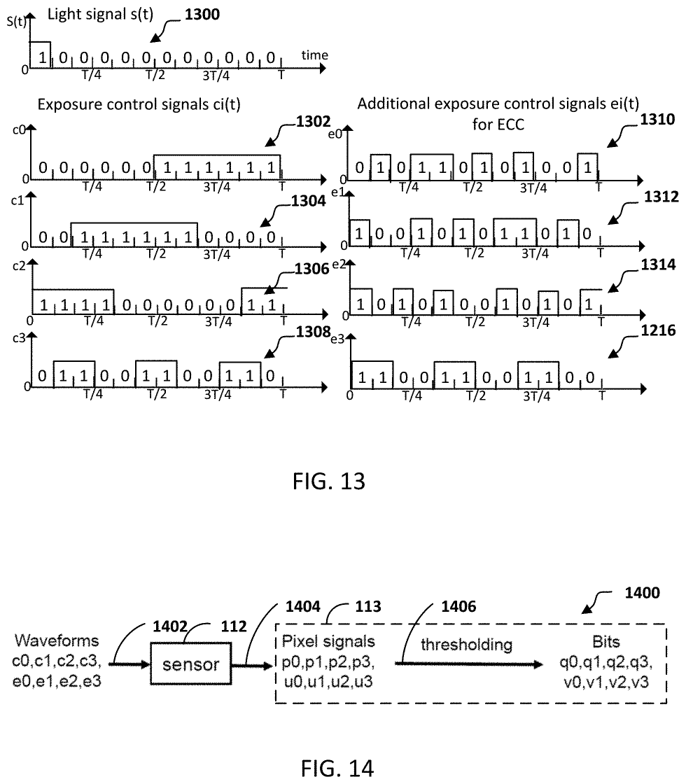

FIG. 13 is a diagram illustrating exposure control signals with respect to Gray4 and the Hamming (8,4) code in the ToF sensor, in accordance with various aspects of the present disclosure. As illustrated in FIG. 13, the exposure control signals include a first set of exposure control signals 1302-1308 and a second set of exposure control signals 1310-1316 relative to a light signal 1300. The first set of exposure control signals 1302-1308 are ToF exposure control signals (e.g., c0, c1, c2, and c3) that control a given pixel to generate ToF pixel signals (e.g., p0, p1, p2, and p3). The second set of exposure control signals 1310-1316 are ECC exposure control signals (e.g., e0, e1, e2, and e3) that control a given pixel to generate ECC pixel signals (e.g., u0, u1, u2, and u3).

The light signal 1300 is a light emitted by a light generator (e.g. the light generator 111). The light signal 1300 is high during the first 1/12 of the period T. The light signal 1300 when divided into twelve durations over period T may be represented by a bit pattern corresponding to 100000000000. FIG. 13 shows one complete cycle of the exposure control signal 1302-1316 and the light signal 1300. In a ToF system these signals are repeated continuously according to the cycle time T.

The exposure control signal 1302 is a first exposure control signal for the given pixel. The exposure control signal 1302 is high during the second half of the period T. The exposure control signal 1302 when divided into twelve durations over period T corresponds to 000000111111.

The exposure control signal 1304 is a second exposure control signal for the given pixel. The exposure control signal 1304 is high during a portion of the period T. The exposure control signal 1304 when divided into twelve durations over period T corresponds to 001111110000.

The exposure control signal 1306 is a third exposure control signal for the given pixel. The exposure control signal 1306 as shown is high during two distinct portions of the period T. Since the signals are periodic and repeats with the same pattern after the initial period, it can be observed that the second high period in 1306 in one cycle will join with the first high period of 1306 in the following cycle. Hence, the signal 1306 is high during one distinct portion of the period T. The exposure control signal 1306 when divided into twelve durations over period T corresponds to 111100000011.

The exposure control signal 1308 is a fourth exposure control signal for the given pixel. The exposure control signal 1308 is high during three distinct portions of the period T. The exposure control signal 1308 when divided into twelve durations over period T corresponds to 011001100110.

The exposure control signal 1310 is a fifth exposure control signal for the given pixel. The exposure control signal 1310 is high during five distinct portions of the period T. The exposure control signal 1310 when divided into twelve durations over period T corresponds to 010110101001.

The exposure control signal 1312 is a sixth exposure control signal for the given pixel. The exposure control signal 1312 is high during five distinct portions of the period T. The exposure control signal 1312 when divided into twelve durations over period T corresponds to 100101011010.

The exposure control signal 1314 is a seventh exposure control signal for the given pixel. The exposure control signal 1314 as shown is high during six distinct portions of the period T. Since the signals are periodic and repeats with the same pattern after the initial period, it can be observed that the sixth high period in 1314 in one cycle will join with the first high period of 1314 in the following cycle. Hence, the signal 1314 is high during five distinct portions of the period T. The exposure control signal 1314 when divided into twelve durations over period T corresponds to 101010010101.

Lastly, the exposure control signal 1316 is an eighth exposure control signal for the given pixel. The exposure control signal 1316 is high during three distinct portions of the period T. The exposure control signal 1316 when divided into twelve durations over period T corresponds to 110011001100.

FIG. 14 is a flowchart illustrating a process 1400 for thresholding pixel signals to produce with ToF and ECC bits, in accordance with various aspects of the present disclosure. As illustrated in FIG. 14, the process 1400 includes an image sensor (e.g., the image sensor 112) receiving eight exposure control signal waveforms c0, c1, c2, c3, e0, e1, e2, and e3 (at arrow 1402) and outputting eight pixel signals p0, p1, p2, p3, u0, u1, u2, and u3 to processing circuitry (e.g., the controller 113) (at arrow 1404). For example, the process 1400 includes an image sensor (e.g., the image sensor 112) receiving eight exposure control signal waveforms as described above in FIGS. 12 and 13.

There are several different ways to generate a region code. One way is to determine a region code directly from the eight pixel signals p0, p1, p2, p3, u0, u1, u2, and u3 with a metric μ and expression (8):

$$n = {argmin}_{j} μ ( ( p 0 , p 1 , p 2 , p 3 , u 0 , u 1 , u 2 , u 3 ) , Rj ) \qquad ( 8 )$$

That is, the region n is found from the regions Rj (j=0,1, . . . ,11) to be the one which has the closest distance based on the metric to be closest to the set of pixel signals. As a result, Rn is the region code.

Another way of generating a region code is to use a thresholding method with an ECC decoder. The process 1400 also includes the processing circuitry (e.g., the controller 113) receiving the eight pixel signals p0, p1, p2, p3, u0, u1, u2, and u3 (at arrow 1404) and thresholding the eight pixel signals p0, p1, p2, p3, u0, u1, u2, and u3 to generate eight threshold bits q0, q1, q2, q3, v0, v1, v2, and v3 (at arrow 1406).

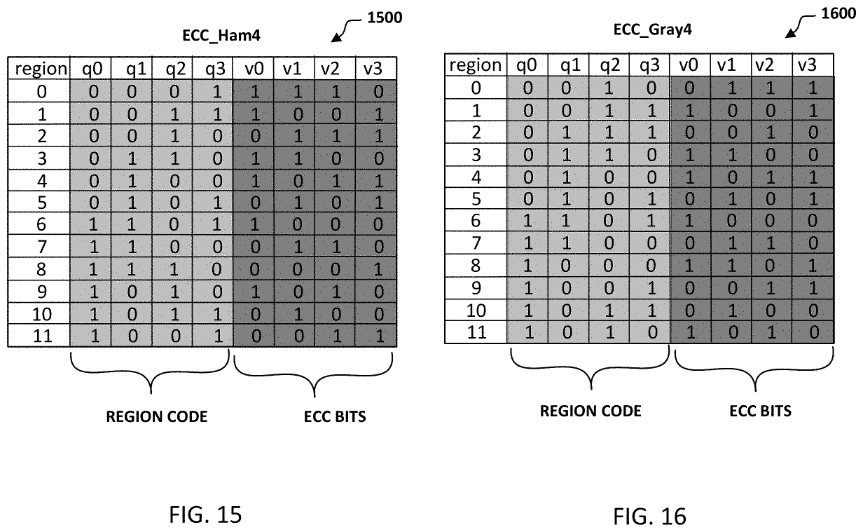

FIG. 15 is a diagram illustrating an array 1500 of codewords with corresponding to Ham4 ECC bits including region code bits and ECC bits, in accordance with various aspects of the present disclosure. The region codes q0, q1, q2, and q3 are threshold bits that are output by the processing circuitry and correspond to the first set of exposure control signals 1202-1208 described in FIG. 12. For example, as illustrated in FIG. 15, q1 is 000111111000 that corresponds to the second exposure control signal 1204 in FIG. 12.

The ECC bits v0, v1, v2, and v3 are threshold bits that are output by the processing circuitry and correspond to the second set of exposure control signals 1210-1216 described in FIG. 12. For example, as illustrated in FIG. 15, v1 is 101101010010 that corresponds to the sixth exposure control signal 1212 in FIG. 12.

FIG. 16 is a diagram illustrating an array 1600 of codewords with corresponding to Gray4 ECC including region code bits and ECC bits, in accordance with various aspects of the present disclosure. The region codes q0, q1, q2, and q3 are threshold bits that are output by the processing circuitry and correspond to the first set of exposure control signals 1302-1308 described in FIG. 13. For example, as illustrated in FIG. 16, q1 is 001111110000 that corresponds to the second exposure control signal 1304 in FIG. 13.

The ECC bits v0, v1, v2, and v3 are threshold bits that are output by the processing circuitry and correspond to the second set of exposure control signals 1310-1316 described in FIG. 13. For example, as illustrated in FIG. 16, v1 is 100101011010 that corresponds to the sixth exposure control signal 1312 in FIG. 13.

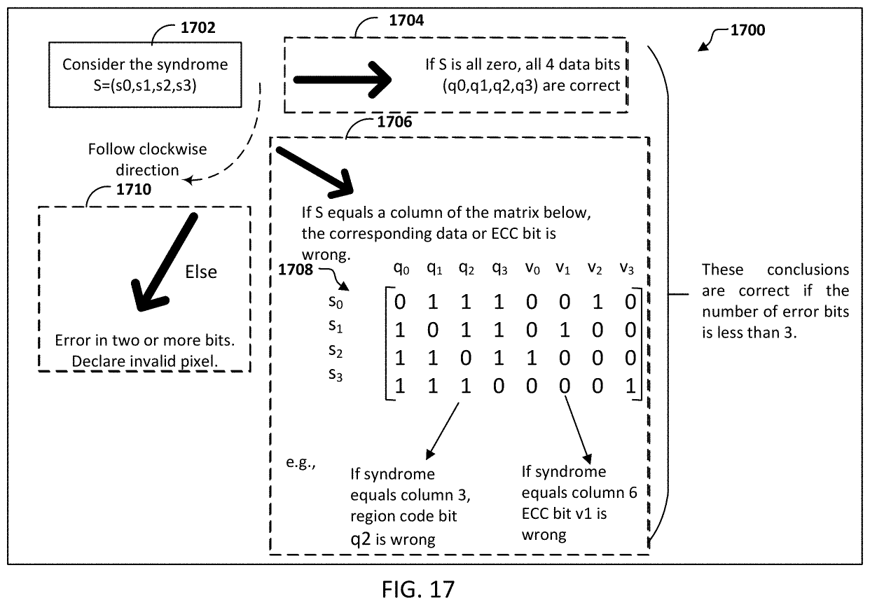

FIG. 17 is a flow diagram illustrating an ECC decoding process 1700 for determining a region code, in accordance with various aspects of the present disclosure. The process 1700 includes the processing circuitry (e.g., the controller 113) considering a syndrome S (s0, s1, s2, and s3) with respect to the threshold bits q0, q1, q2, q3, v0, v1, v2, and v3 (at block 1702). The syndrome S is calculated by the processing circuitry with a matrix multiplication illustrated in Expression (4) below.

$$S = [ \begin{matrix}s 0 \\ s 1 \\ s 2 \\ s 3\end{matrix} ] = [ \begin{matrix}0 & 1 & 1 & 1 & 0 & 0 & 1 & 0 \\ 1 & 0 & 1 & 1 & 0 & 1 & 0 & 0 \\ 1 & 1 & 0 & 1 & 1 & 0 & 0 & 0 \\ 1 & 1 & 1 & 0 & 0 & 0 & 0 & 1\end{matrix} ] [ \begin{matrix}q 0 \\ q 1 \\ ⋮ \\ v 2 \\ v 3\end{matrix} ] \qquad ( 4 )$$

The calculations in Expression (4) are performed on bits with a modulo 2 calculation. Consequently, the addition operations are equivalent to exclusive-OR operations. From Expression (4), s0=0 * q0+1 * q1+1 * q2+1 * q3+0 * v0+0 * v1+1 * v2+0 * v3 (modulo 2)=q1 XOR q2 XOR q3 XOR v2.

When the error bits are less than three bits, the process 1700 includes the processing circuitry determining whether s0, s1, s2, and s3 of the syndrome S are all zero (at block 1704). When determining that s0, s1, s2, and s3 of the syndrome S are all zero, the processing circuitry determines that the region code (i.e., threshold bits q0, q1, q2, and q3) is correct.

When the error bits are less than three bits, the process 1700 includes the processing circuitry determining whether s0, s1, s2, and s3 of the syndrome S are equal to a column in the matrix 1708 shown in FIG. 17 to determine whether one of the threshold bits q0, q1, q2, q3, v0, v1, v2, and v3 is incorrect (at block 1706). For example, when determining that s0, s1, s2, and s3 of the syndrome S are equal to column 3 (i.e., 1101), the processing circuitry determines that the threshold bit q2 is incorrect. Alternatively, when determining that s0, s1, s2, and s3 of the syndrome S are equal to column 6 (i.e., 0100), the processing circuitry determines that the threshold ECC bit v1 is incorrect.

Lastly, the process 1700 includes the processing circuitry determining whether there is an error in two or more bits (at block 1710). When the syndrome S is not zero and not equal to any column in the matrix 1708 shown in FIG. 17, the processing circuitry determines that there is an error in two or more bits. In this case, the processing circuitry may declare the given pixel an invalid pixel.

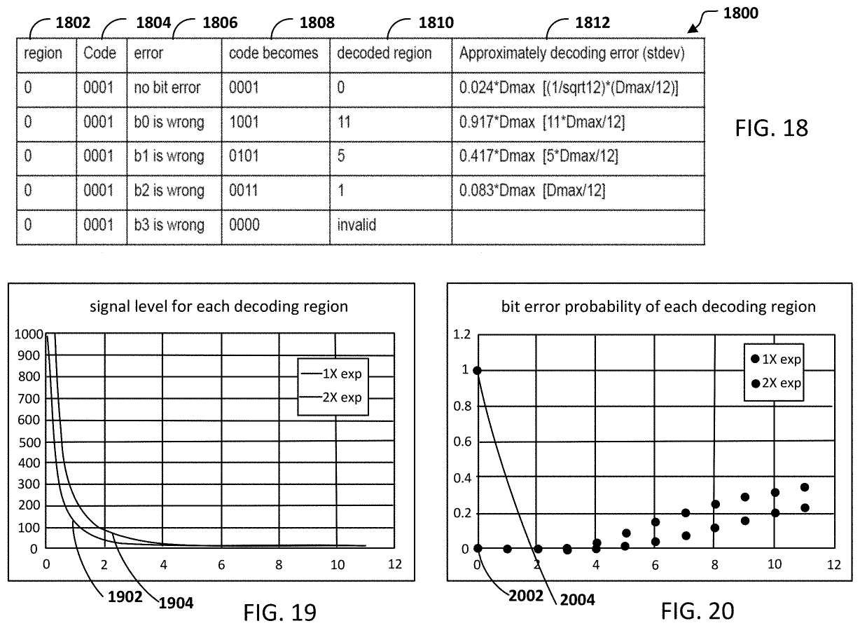

FIG. 18 is a chart illustrating approximate decoding error based on a particular bit error. As illustrated in FIG. 18, the chart 1800 includes a region column 1802, a code column 1804, an error column 1806, a code error column 1808, a decoded region column 1810, and an approximate decoding error column 1812.

The region column 1802 includes five different examples of region 0. The code column 1805 includes five different examples where the true region is region 0 (which is 0001 in Ham4). The error column 1806 includes five different examples of an error status of the region code for the region 0: 1) no bit error, 2) b0 is wrong, 3) b1 is wrong, 4) b2 is wrong, and 5) b3 is wrong.

The code error column 1808 includes five different examples of the region code in the code column 1804 with respect to the error column 1806: 1) region code is 0001 because there is no bit error, 2) region code is 1001 because b0 is wrong, 3) region code is 0101 because b1 is wrong, 4) region code is 0011 because b2 is wrong, 5) region code is 0000 because b3 is wrong.

The decoded region column 1810 includes five different examples of a decoded region from the region code in the code error column 1808: 1) region 0, 2) region 11, 3) region 5, 4) region 1, and 5) invalid.

Lastly, the approximate decoding error column 1812 includes five different examples of an approximate decoding error with respect to the decoded region column 1810: 1) 0.024*dₘₐₓ, 2) 0.917* dₘₐₓ, 3) 0.417* dₘₐₓ, 4) 0.083* dₘₐₓ, and 5) invalid. As illustrated in FIG. 18, a single bit error (e.g., bit b0) in the region code may result in an object located in region 0 being interpreted as being located in region 11, which is a significant error. Consequently, the decoded distance error is much larger when the region code is incorrectly determined.

While ECC is one way to correct an incorrect region, another way to reduce the likelihood of an incorrect region is to double the exposure time. FIG. 19 is a chart illustrating a ToF sensor signal level across decoding regions for two different exposure times. Specifically, 1X exposure 1902 (1X exp in graph) is set to just below saturation (represented by the value 1000) at region 0, and 2X exposure 1904 (2X exp in graph) is set to two times as long as 1x exposure 1902. As illustrated in FIG. 19, the ToF sensor signal level is 1000 in region 0 for both 1X exposure 1902 and 2X exposure 1904. However, there is no signal saturation for the 1x exposure, whereas the 2X exposure 1904 is saturated in region 0.

At region 1, the ToF sensor signal level drops to 100 for the 1X exposure 1902 and 200 for the 2X exposure 1904. At region 2, the ToF sensor signal level drops to 50 for the 1x exposure 1902 and 100 for the 2X exposure 1904. At region 3, the ToF sensor signal level drops to 25 for the 1x exposure 1902 and 50 for the 2X exposure 1904. At regions 4-11, the ToF sensor signal continues to drop from one region to another for the 1x exposure 1902 and 50 for the 2X exposure 1904.

FIG. 20 is a chart illustrating a bit error probability of each decoding region for two different exposure times. Specifically, 1x exposure 2002 and 2X exposure 2004. As illustrated in FIG. 20, the bit error probability of the 2X exposure 2004 is 100% at region 0 because of the oversaturation of the 2X exposure 2004 at region 0.

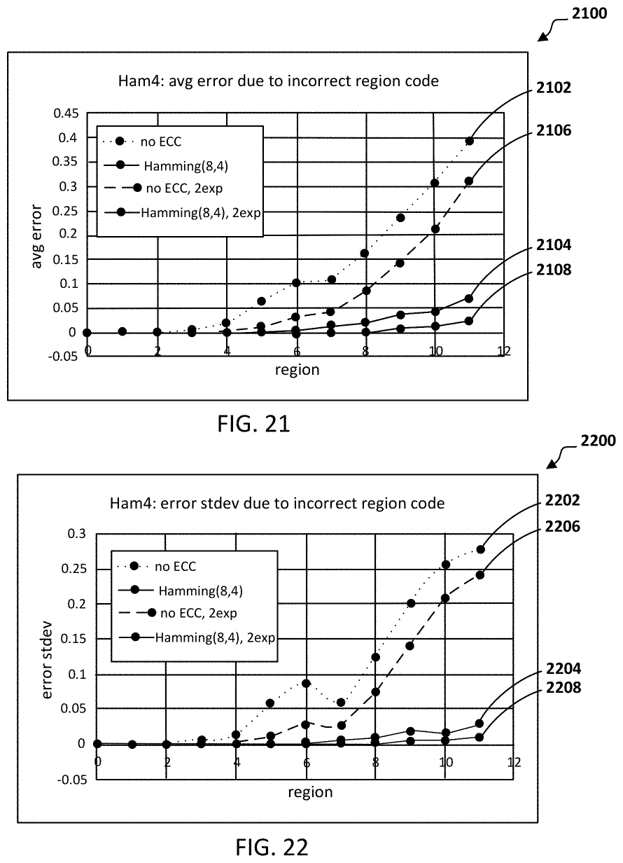

FIG. 21 is a chart illustrating an average error due to incorrect region code with Ham4 ECC bits, in accordance with various aspects of the present disclosure. As illustrated in FIG. 21, the chart 2100 includes an average error with no ECC 2102, an average error with Hamming (8,4) 2104, an average error with no ECC and 2X exposure 2106, and an average error with Hamming (8,4) and 2X exposure 2108.

As illustrated in FIG. 21, at regions 0-3, the average error is approximately 0% for the no ECC 2102, approximately 0% for the Hamming (8,4) 2104, approximately 0% for no ECC and 2X exposure 2106, and approximately 0% for Hamming (8,4) and 2X exposure 2108.

Further, as illustrated in FIG. 21, at region 4, the average error is approximately 2.5% for the no ECC 2102, approximately 0% for the Hamming (8,4) 2104, approximately 0% for no ECC and 2X exposure 2106, and approximately 0% for Hamming (8,4) and 2X exposure 2108.

Additionally, as illustrated in FIG. 21, at region 8, the average error is approximately 17% for the no ECC 2102, approximately 2.5% for the Hamming (8,4) 2104, approximately 8% for no ECC and 2X exposure 2106, and approximately 0% for Hamming (8,4) and 2X exposure 2108.

Lastly, as illustrated in FIG. 21, at region 11, the average error is approximately 38% for the no ECC 2102, approximately 6% for the Hamming (8,4) 2104, approximately 32% for no ECC and 2X exposure 2106, and approximately 2.5% for Hamming (8,4) and 2X exposure 2108.

FIG. 22 is a chart illustrating a standard deviation error due to incorrect region code with Ham4 ECC bits, in accordance with various aspects of the present disclosure. As illustrated in FIG. 22, the chart 2200 includes a standard deviation error with no ECC 2202, a standard deviation error with Hamming (8,4) 2204, a standard deviation error with no ECC and 2X exposure 2206, and a standard deviation error with Hamming (8,4) and 2X exposure 2208.

As illustrated in FIG. 22, at regions 0-3, the standard deviation error is approximately 0% for the no ECC 2202, approximately 0% for the Hamming (8,4) 2204, approximately 0% for no ECC and 2X exposure 2206, and approximately 0% for Hamming (8,4) and 2X exposure 2208.

Further, as illustrated in FIG. 22, at region 4, the standard deviation error is approximately 2.5% for the no ECC 2202, approximately 0% for the Hamming (8,4) 2204, approximately 0% for no ECC and 2X exposure 2206, and approximately 0% for Hamming (8,4) and 2X exposure 2208.

Additionally, as illustrated in FIG. 22, at region 8, the standard deviation error is approximately 13% for the no ECC 2202, approximately 2.5% for the Hamming (8,4) 2204, approximately 7.5% for no ECC and 2X exposure 2206, and approximately 0% for Hamming (8,4) and 2X exposure 2208.

Lastly, as illustrated in FIG. 22, at region 11, the standard deviation error is approximately 27.5% for the no ECC 2202, approximately 2.5% for the Hamming (8,4) 2204, approximately 24% for no ECC and 2X exposure 2206, and approximately 1% for Hamming (8,4) and 2X exposure 2208.

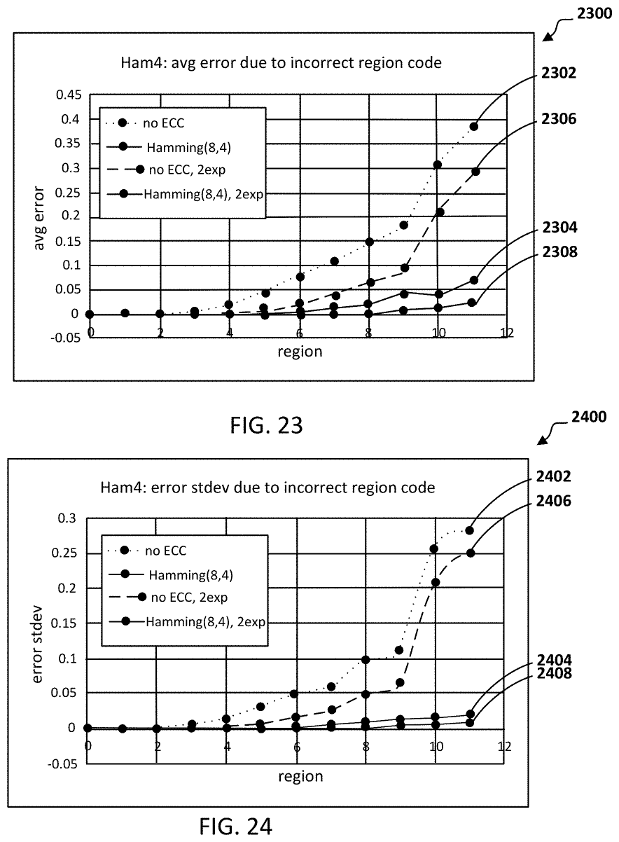

FIG. 23 is a chart illustrating an average error due to incorrect region code with Gray4 ECC bits, in accordance with various aspects of the present disclosure. As illustrated in FIG. 23, the chart 2300 includes an average error with no ECC 2302, an average error with Hamming (8,4) 2304, an average error with no ECC and 2X exposure 2306, and an average error with Hamming (8,4) and 2X exposure 2308.

As illustrated in FIG. 23, at regions 0-3, the average error is approximately 0% for the no ECC 2302, approximately 0% for the Hamming (8,4) 2304, approximately 0% for no ECC and 2X exposure 2306, and approximately 0% for Hamming (8,4) and 2X exposure 2308.

Further, as illustrated in FIG. 23, at region 4, the average error is approximately 2.5% for the no ECC 2302, approximately 0% for the Hamming (8,4) 2304, approximately 0% for no ECC and 2X exposure 2306, and approximately 0% for Hamming (8,4) and 2X exposure 2308.

Additionally, as illustrated in FIG. 23, at region 8, the average error is approximately 15% for the no ECC 2302, approximately 2.5% for the Hamming (8,4) 2304, approximately 7.5% for no ECC and 2X exposure 2306, and approximately 0% for Hamming (8,4) and 2X exposure 2308.

Lastly, as illustrated in FIG. 23, at region 11, the average error is approximately 38% for the no ECC 2302, approximately 4% for the Hamming (8,4) 2304, approximately 29% for no ECC and 2X exposure 2306, and approximately 1% for Hamming (8,4) and 2X exposure 2308.

FIG. 24 is a chart illustrating a standard deviation error due to incorrect region code with Gray4 ECC bits, in accordance with various aspects of the present disclosure. As illustrated in FIG. 24, the chart 2400 includes a standard deviation error with no ECC 2402, a standard deviation error with Hamming (8,4) 2404, a standard deviation error with no ECC and 2X exposure 2406, and a standard deviation error with Hamming (8,4) and 2X exposure 2408.

As illustrated in FIG. 24, at regions 0-3, the standard deviation error is approximately 0% for the no ECC 2402, approximately 0% for the Hamming (8,4) 2404, approximately 0% for no ECC and 2X exposure 2406, and approximately 0% for Hamming (8,4) and 2X exposure 2408.

Further, as illustrated in FIG. 24, at region 4, the standard deviation error is approximately 2.5% for the no ECC 2402, approximately 0% for the Hamming (8,4) 2404, approximately 0% for no ECC and 2X exposure 2406, and approximately 0% for Hamming (8,4) and 2X exposure 2408.

Additionally, as illustrated in FIG. 24, at region 8, the standard deviation error is approximately 10% for the no ECC 2402, approximately 1% for the Hamming (8,4) 2404, approximately 5% for no ECC and 2X exposure 2406, and approximately 0% for Hamming (8,4) and 2X exposure 2408.

Lastly, as illustrated in FIG. 24, at region 11, the standard deviation error is approximately 28% for the no ECC 2402, approximately 2.5% for the Hamming (8,4) 2404, approximately 25% for no ECC and 2X exposure 2406, and approximately 1% for Hamming (8,4) and 2X exposure 2408.

As illustrated in FIGS. 21-24, the average error and standard deviation error is significantly lower with the Hamming (8,4) using Ham4 or Gray4 ECC bits than no ECC. Moreover, Hamming (8,4) 1X exposure is not significantly different from Hamming (8,4) 2X exposure and Hamming (8,4) 2X exposure is oversaturated at region 8 as explained above.

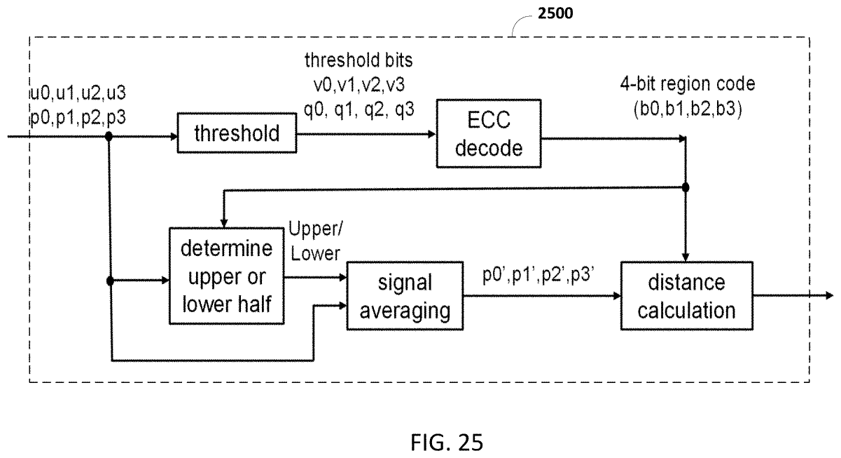

FIG. 25 is a diagram illustrating a second example of a controller 2500 with a ToF/ECC decoder, in accordance with various aspects of the present disclosure. The controller 2500 may be similar to the controller 113 of FIG. 7.

For example, similar to the controller 113 of FIG. 7, the controller 2500 performs thresholding on both the pixel signals p0, p1, p2, and p3 and the ECC pixel signals u0, u1, u2, and u3 to produce the bits q0, q1, q2, q3, v0, v1, v2, v3, and then input these bits into the ECC decoder.

Further, similar to the controller 113, the controller 2500 with the ToF/ECC decoder generates a 4-bit region code (b0, b1, b2, and b3) using both the threshold TOF bits q0, q1, q2, and q3 and the threshold ECC bits v0, v1, v2, and v3.

However, unlike the controller 113, the controller 2500 includes a step to determine an upper half or a lower half of a half shifted region using the 4-bit region code (b0, b1, b2, and b3) from the ECC decoder, as well as either the raw form of the pixel signals p0, p1, p2, and p3 and the ECC pixel signals u0, u1, u2, and u3, or the threshold bits q0, q1, q2, q3, v0, v1,v2, v3.

Further, unlike the controller 113, the controller 2500 performs a distance calculation using the upper half or the lower half of the half shifted region that is determined (e.g., a single bit indicating upper half or lower half), the raw form of the pixel signals p0, p1, p2, and p3 and the ECC pixel signals u0, u1, u2, and u3, and the 4-bit region code. The distance calculation by the controller 2500 is an improvement over the distance calculation by the controller 113 because the distance calculation may be performed when the decoded signal level is lower than 0.7% of full scale, which is not possible with the controller 113. For example, the controller 2500 may perform the distance calculation when the decoded signal level is at 0.3% of full scale.

In some examples, the distance calculation may also include or be after averaging the raw form of the pixel signals p0, p1, p2, and p3 and selected ECC pixel signals u0, u1, u2, and u3 according to the lower half or the upper half of the region code to generate averaged pixel signals p0′, p1′, p2′, and p3′ as discussed in greater detail below. The averaged pixel signals p0′, p1′, p2′, and p3′ may then be used for the distance calculation.

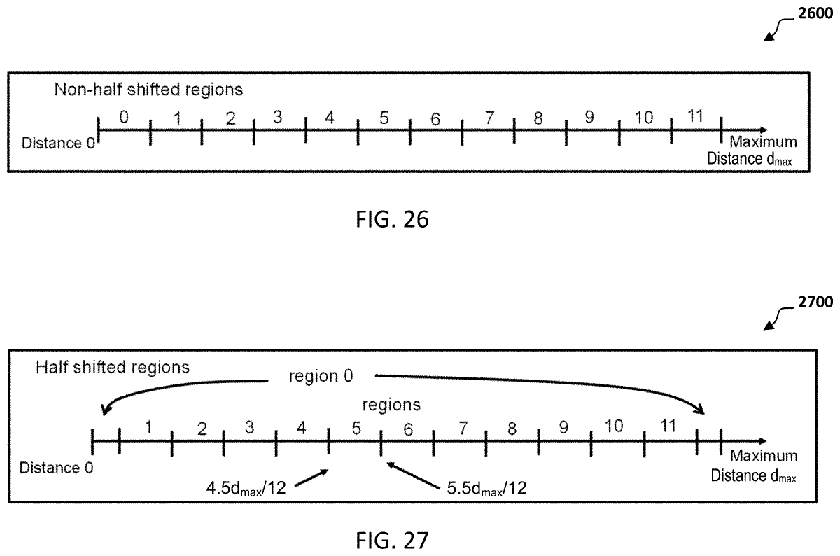

FIG. 26 is a chart illustrating non-half shifted regions 2600 and corresponds to FIG. 3, in accordance with various aspects of the present disclosure. In FIGS. 3 and 26, the controller 113 is making a region decision to determine whether the object is located in one of twelve regions between zero distance and the maximum distance dₘₐₓ. When the controller 113 performs thresholding of the pixel signals to determine a region, the resulting region does not correspond to one of the regions in FIG. 26. Instead, the resulting region is one of the half-shifted regions shown in FIG. 27.

FIG. 27 is a chart illustrating half shifted regions 2700, in accordance with various aspects of the present disclosure. As illustrated in FIG. 27, the half shifted regions 2600 include twelve regions, and each region i (i=1, 2, . . . , 11) spans the distance from (i-0.5)dₘₐₓ/12 to (i+0.5)dₘₐₓ/12. As illustrated, region 0 includes two halves where one half of region 0 is before region 1 and the other half of region 0 is after region 11. In other words, we may interpret region 0 to span from 11.5D/12 to 0.5D/12 in a wrap around fashion. All the regions in FIG. 27 are shifted by the size of a half region relative to the regions in FIG. 26. For this reason, the regions in FIG. 27 are referred to as “half shifted regions.”

With respect to lower half, as illustrated in FIG. 27, the lower half of region 5 spans from 4.5dₘₐₓ/12 to 5dₘₐₓ/12. With respect to the upper half, as illustrated in FIG. 27, the upper half of region 5 spans from 5dₘₐₓ/12 to 5.5 dₘₐₓ/12.

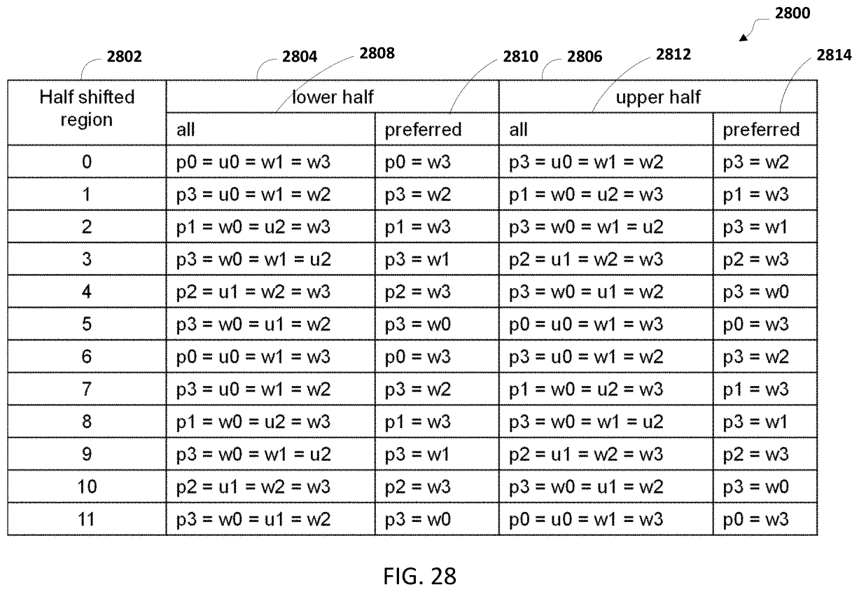

FIG. 28 is a table of equivalent signals 2800 for each half (upper half, lower half) of the half shifted regions, in accordance with various aspects of the present disclosure. The table of equivalent signals 2800 includes three columns: half shifted region column 2802, lower half column 2804, and upper half column 2806. The table of equivalent signals 2800 may be a look-up table in the controller 2500.

The half shifted region column 2802 includes a row for each of the twelve half shifted regions 0-11 of FIG. 27. The lower half column 2804 includes two sub-columns: all equivalent pixel signals column 2808 and preferred equivalent pixel signals column 2810. The all pixel equivalent pixel signals column 2808 includes an indication of equivalent signals between the pixel signals p0, p1, p2, and p3, the ECC pixel signals u0, u1, u2, and u3, and the complementary signals w0, w1, w2, and w3 for a lower half of the respective half shifted regions 0-11.

The complementary signals w0, w1, w2, and w3 are based on the ECC pixel signals. The complementary signal w0 is equal to the difference between 1 and u0, the complementary signal w1 is equal to the difference between 1 and u1, the complementary signal w2 is equal to the difference between 1 and u2, and the complementary signal w3 is equal to the difference between 1 and u3.

The preferred equivalent pixel signals column 2810 includes an indication of the preferred equivalent signals between the pixel signals p0, p1, p2, and p3, the ECC pixel signals u0, u1, u2, and u3, and the complementary signals w0, w1, w2, and w3 for a lower half of the respective half shifted regions 0-11. The preferred equivalent signals are preferred because these transitions are less sharply or more gently near the region. Stated differently, the preferred equivalent signals are preferred because the preferred equivalent signals do not change from a downward slope to an upward slope, or from an upward slope to a downward slope. Instead, the preferred equivalent signals only changes, for example, from a downward slope to a flat slope, from a flat slope to an upward slope, etc.

A sharper transition in the current region is indicative of a high frequency transition, and high frequency transitions will not be as “sharp” as the ideal case due to sensor bandwidth limitations. Transitions that deviate from the ideal will introduce more signal distortion. Therefore, a gentler transition in the current region is indicative of a lower frequency transition relative to the high frequency transitions, and the lower frequency transition will be less impacted by the sensor bandwidth limitations. The lower frequency transition will introduce less distortion.

For the lower half of half shifted region 0, the all pixel equivalent pixel signals column 2808 is p0=u0=w1=w3 and the preferred pixel signals column 2810 is p0=w3. For the lower half of half shifted region 1, the all pixel equivalent pixel signals column 2808 is p3=u0=w1=w2 and the preferred pixel signals column 2810 is p3=w2. For the lower half of half shifted region 2, the all pixel equivalent pixel signals column 2808 is p1=w0=u2=w3 and the preferred pixel signals column 2810 is p1=w3. For the lower half of half shifted region 3, the all pixel equivalent pixel signals column 2808 is p3=w0=w1=u2 and the preferred pixel signals column 2810 is p3=w1. For the lower half of half shifted region 4, the all pixel equivalent pixel signals column 2808 is p2=u1=w2=w3 and the preferred pixel signals column 2810 is p2=w3. For the lower half of half shifted region 5, the all pixel equivalent pixel signals column 2808 is p3=w0=u1=w2 and the preferred pixel signals column 2810 is p3=w0. For the lower half of half shifted region 6, the all pixel equivalent pixel signals column 2808 is p0=u0=w1=w3 and the preferred pixel signals column 2810 is p0=w3. For the lower half of half shifted region 7, the all pixel equivalent pixel signals column 2808 is p3=u0=w1=w2 and the preferred pixel signals column 2810 is p3=w2. For the lower half of half shifted region 8, the all pixel equivalent pixel signals column 2808 is p1=w0=u2=w3 and the preferred pixel signals column 2810 is p1=w3. For the lower half of half shifted region 9, the all pixel equivalent pixel signals column 2808 is p3=w0=w1=u2 and the preferred pixel signals column 2810 is p3=w1. For the lower half of half shifted region 10, the all pixel equivalent pixel signals column 2808 is p2=u1=w2=w3 and the preferred pixel signals column 2810 is p2=w3. For the lower half of half shifted region 11, the all pixel equivalent pixel signals column 2808 is p3=w0=u1=w2 and the preferred pixel signals column 2810 is p3=w0.

The upper half column 2806 also includes two sub-columns: all equivalent pixel signals column 2812 and preferred equivalent pixel signals column 2814. The all pixel equivalent pixel signals column 2812 includes an indication of equivalent signals between the ToF pixel signals p0, p1, p2, and p3, the ECC pixel signals u0, u1, u2, and u3, and the complementary signals w0, w1, w2, and w3 for an upper half of the respective half shifted regions 0-11.

The preferred equivalent pixel signals column 2814 includes an indication of the preferred equivalent signals between the pixel signals p0, p1, p2, and p3, the ECC pixel signals u0, u1, u2, and u3, and the complementary signals w0, w1, w2, and w3 for an upper half of the respective half shifted regions 0-11. The preferred equivalent signals are preferred because these transitions are less sharply near the region.

For the upper half of half shifted region 0, the all pixel equivalent pixel signals column 2812 is p3=u0=w1=w2 and the preferred pixel signals column 2814 is p3=w2. For the upper half of half shifted region 1, the all pixel equivalent pixel signals column 2812 is p1=w0=u2=w3 and the preferred pixel signals column 2814 is p1=w3. For the upper half of half shifted region 2, the all pixel equivalent pixel signals column 2812 is p3=w0=w1=u2 and the preferred pixel signals column 2814 is p3=w1. For the upper half of half shifted region 3, the all pixel equivalent pixel signals column 2812 is p2=u1=w2=w3 and the preferred pixel signals column 2814 is p2=w3. For the upper half of half shifted region 4, the all pixel equivalent pixel signals column 2812 is p3=w0=u1=w2 and the preferred pixel signals column 2814 is p3=w0. For the upper half of half shifted region 5, the all pixel equivalent pixel signals column 2812 is p0=u0=w1=w3 and the preferred pixel signals column 2814 is p0=w3. For the upper half of half shifted region 6, the all pixel equivalent pixel signals column 2812 is p3=u0=w1=w2 and the preferred pixel signals column 2814 is p3=w2. For the upper half of half shifted region 7, the all pixel equivalent pixel signals column 2812 is p1=w0=u2=w3 and the preferred pixel signals column 2814 is p1=w3. For the upper half of half shifted region 8, the all pixel equivalent pixel signals column 2812 is p3=w0=w1=u2 and the preferred pixel signals column 2814 is p3=w1. For the upper half of half shifted region 9, the all pixel equivalent pixel signals column 2812 is p2=u1=w2=w3 and the preferred pixel signals column 2814 is p2=w3. For the upper half of half shifted region 10, the all pixel equivalent pixel signals column 2812 is p3=w0=u1=w2 and the preferred pixel signals column 2814 is p3=w0. For the upper half of half shifted region 11, the all pixel equivalent pixel signals column 2812 is p0=u0=w1=w3 and the preferred pixel signals column 2814 is p0=w3.

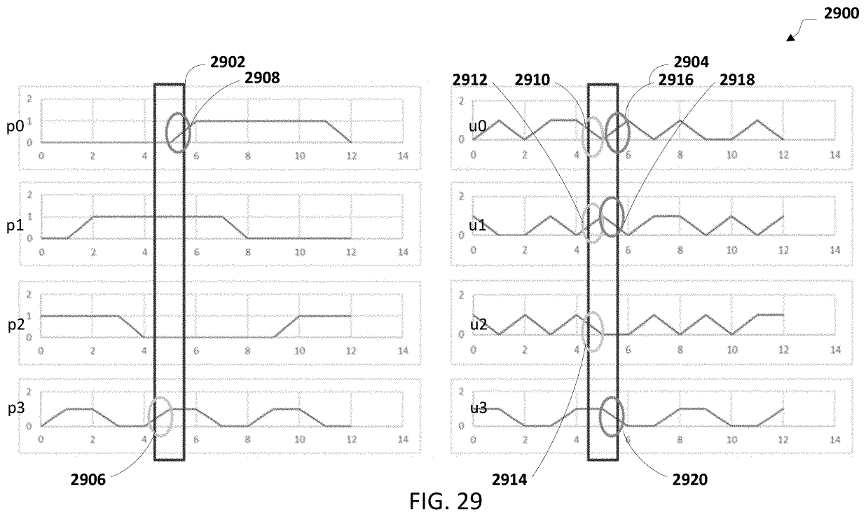

FIG. 29 is a chart illustrating highlighted sections 2902 and 2904 with respect to the equivalent signals 2800 for the half shifted regions, in accordance with various aspects of the present disclosure. The horizontal axes of the graphs correspond to object distance. In the example of FIG. 29, rectangles are drawn to highlight the sections 2902 and 2904 regarding the pixel signals and the ECC pixel signals, respectively, which are indicative of region 5 that spans from 4.5dₘₐₓ/12 to 5.5dₘₐₓ/12. The highlighted sections 2902 and 2904 are also indicative of lower half and upper half, where the lower half corresponds to the left half of the rectangles which spans from 4.5dₘₐₓ/12 to 5dₘₐₓ/12, and the upper half corresponds to the right half of the rectangles which spans from 5dₘₐₓ/12 to 5.5 dₘₐₓ/12.

Each of the highlighted sections 2902 and 2904 also include a “transition,” where a pixel signal transitions from 0 to 1 or 1 to 0 while crossing over an edge of the highlighted section. For example, the highlighted section 2902 includes two transitions 2906 and 2908. The transition 2906 is an increasing transition (0 to 1) of the pixel signal p3 that occurs in the lower half of half shifted region 5. The transition 2908 is an increasing transition (0 to 1) of the pixel p0 that occurs in the upper half of the half shifted region 5.

The highlighted section 2904 includes six transitions 2910-2920 of the ECC pixel signals. The transition 2910 is a decreasing transition (1 to 0) of the pixel signal u0 that occurs in the lower half of the half shifted region 5. The transition 2912 is an increasing transition (0 to 1) of the pixel signal u1 that occurs in the lower half of the half shifted region 5. The transition 2914 is a decreasing transition (1 to 0) of the pixel signal u2 that occurs in the lower half of the half shifted region 5. The transition 2916 is an increasing transition (0 to 1) of the pixel signal u0 that occurs in the upper half of the half shifted region 5. The transition 2918 is a decreasing transition (1 to 0) of pixel signal u1 that occurs in the upper half of the half shifted region 5. The transition 2920 is a decreasing transition (1 to 0) of pixel signal u3 that occurs in the upper half of the half shifted region 5.

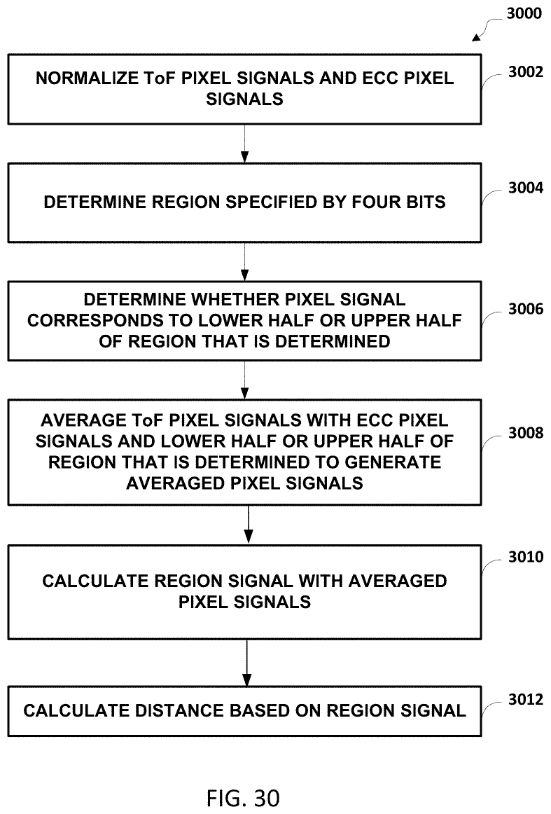

FIG. 30 is a flowchart illustrating an example process 3000 for determining an object distance, in accordance with various aspects of the present disclosure. FIG. 30 is described with respect to the controller 2500 of FIG. 25.

The example process 3000 includes the controller 2500 normalizes the ToF pixel signals p0, p1, p2, and p3 and the ECC pixel signals u0, u1, u2, and u3 (at block 3002). For example, the controller 2500 applies a threshold to normalize the ToF pixel signals p0, p1, p2, and p3 and the ECC pixel signals u0, u1, u2, and u3 to values in the range between 0 and 1.

The example process 3000 includes the controller 2500 determining a region specified by four bits b0, b1, b2, and b3 (at block 3004). For example, the controller 2500 determines a half shifted region n and the four bits may be bn0, bn1, bn2, and bn3.

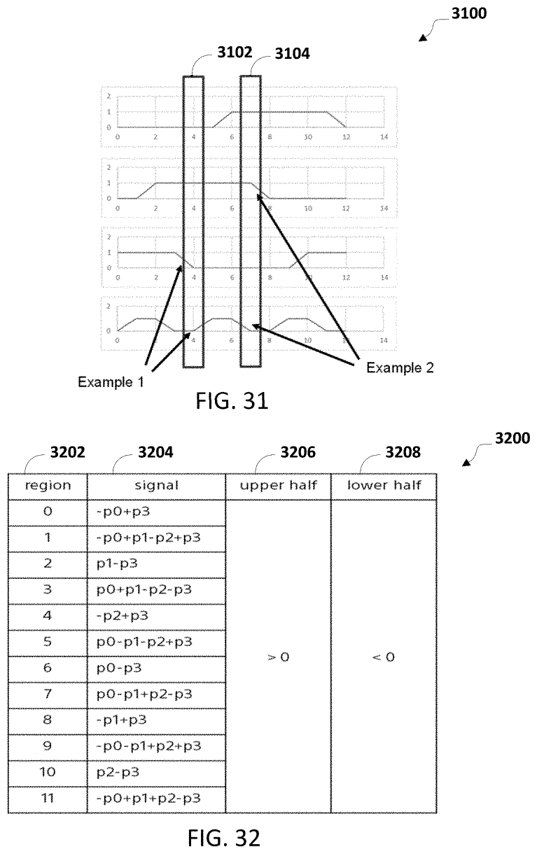

The example process 3000 includes the controller 2500 determining whether a pixel signal corresponds to a lower half or an upper half of the region that is determined (at block 3006). For example, the controller 2500 performs one or more of the techniques described below with respect to FIGS. 31-37.

The example process 3000 includes the controller 2500 averaging ToF pixel signals p0, p1, p2, and p3 with the ECC pixel signals u0, u1, u2, and u3 to generate one or more averaged pixel signals p0′, p1′, p2′, and p3′ based on the lower half or the upper half of the region that is determined (at block 3008). The ToF pixel signals p0, p1, p2, and p3 and the ECC pixel signals u0, u1, u2, and u3 are noisy signals and the noise in each pixel signal is independent of the other pixel signals. Therefore, averaging of the pixel signals may reduce noise.

There are two approaches for averaging equivalent signals. In a first approach, the preferred equivalent signals may be averaged to reduce noise. In an example of the first approach, where the pixel signal corresponds to the lower half of half shifted region 5, then the preferred equivalent signal relationship is p3=w0=1−u0 from the table of FIG. 28, which may be a look-up table in the controller 2500.

From the ECC decoder, the controller 2500 determines whether there is any error in p3 and u0. Therefore, averaging may be done in one of the following ways depending on the ECC decoding result: when ECC decoder indicates no error in p3 and u0, then p3′=(p3+1−u0)/2, when ECC decoder indicates no error in p3, but there is an error in u0, then p3′=p3, and when ECC decoder indicates an error in p3, and no error in u0, then p3′=1−u0. Furthermore, when the controller 2500 knows from the pixel signal plots that in the lower half of region 5, p0=p2=0 and p1=1, then the controller 2500 may set these values for p0, p1, p2 to further reduce noise. Consequently, the averaged pixel signals p0′, p1′, and p2′ is equal to 0, 1, 0, whereas p3′ is the averaged value as calculated before.

The above gives a first example of averaging using the lower half of region 5. The process of averaging using the ECC decoder results, ToF pixel signals, and ECC pixel signals for the upper half of region 5 and for regions other than region 5 may be performed similarly using the equivalent signal relationship as shown in FIG. 28.

In a second approach, all of the equivalent signals may be averaged to reduce noise. Where the signal corresponds to the lower half of half shifted region 5, then the preferred equivalent signal relationship is p3=w0=u1=w2 or equivalently p3=1−u0=u1=1−u2 from the table of FIG. 28, which may be a look-up table in the controller 2500. From the ECC decoder, the controller 2500 determines whether there is any error in p3, u0, u1 and u2. Therefore, the controller 2500 may average the pixel signals in one of the following ways depending on the ECC decoding result: when ECC decoder indicates no error in p3, u0, u1 and u2, then p3′=(p3+1−u0+u1+1−u2)/4, and when ECC decoder indicates an error in p3, u0, u1 or u2, the pixel signal with error is discarded. The averaged pixel value p3′ is calculated as an average of the remaining elements p3, 1−u0, u1 and 1−u2 that have no error.

Similarly, the controller 2500 knows from the pixel signal plots that in the lower half of region 5, p0=p2=0 and p1=1. Therefore, the controller 2500 may set these values for p0, p1, and p2 to further reduce noise. Consequently, the averaged pixel signals p0′, p1′, and p2′ is equal to 0, 1, 0, whereas p3′ is the averaged value as calculated before.

The above gives a second example of averaging using the lower half of region 5. The process of averaging using the ECC decoder results, ToF pixel signals, and ECC pixel signals for the upper half of region 5 and for regions other than region 5 may be performed similarly.

Comparing the second approach to the first approach, the second approach may provide better noise performance because averaging more signal components further reduces noise. However, the second approach may require higher bandwidth in the sensor circuit so that bandwidth related distortion is lower.

Referring back to FIG. 30, the example process 3000 includes calculating the region signal with the averaged pixel signals (at block 3010). For example, using the C programming language, the region signal f(n−1), f(n), and f(n+1) may be calculated using Expression (5):

f(k)=((bk0==1)?p0′:r0′))+((bk1==1)?p1′:r1′))+

((bk0==1)?p2′:r2′))+((bk0==1)?p2′:r2′)) (5)

In the above expression, r0′=1-p0′, r1′=1-p1′,r2′=1-p2′, r3′=1-p3′, and (a==b)?c:d means when a equals b, then c otherwise d.

The example process 3000 also includes calculating the distance based on the region signal that is calculated (at block 3012). For example, the distance d may be calculated using Expression (6):

d=dₘₐₓ*(ratio−2+(n−1)mod12)/12 (6)

In the above expression, the ratio may be defined as Expression (7):

ratio=6*f(n+1)/(f(n+1)+f(n−1)) (7)

FIG. 31 is a chart illustrating two of a plurality of ToF pixel signals 3100 changing in each half shifted region, in accordance with various aspects of the present disclosure. The horizontal axes of the graphs correspond to object distance. In the example of FIG. 31, the plurality of ToF pixel signals 3100 includes ToF pixel signals p0, p1, p2, and p3 with values between 0 and 1, where two ToF pixel signals change in each half shifted region. The chart also includes two highlighted section 3102 and 3104.

The highlighted section 3102 is with respect to region 4 and ToF pixel signals p2 and p3 are changing in the highlighted section 3102. The highlighted section 3104 is with respect to region 7 and ToF pixel signals p1 and p3 are changing in the highlighted section 3104.

FIG. 32 is a table illustrating first example calculations 3200 to determine a lower half or a upper half in a half shifted region, in accordance with various aspects of the present disclosure. The table of first example calculations 3200 includes four columns: half shifted region column 3202, signal column 3204, upper half column 3206, and lower half column 3208. The half shifted region column 3202 includes a row for each of the twelve half shifted regions 0-11.

The signal column 3204 includes a signal calculation to determine an upper half or a lower half of a particular region. The signal calculation for half shifted region 0 is −p0+p3. The signal calculation for half shifted region 1 is −p0+p1−p2+p3. The signal calculation for half shifted region 2 is p1−p3. The signal calculation for half shifted region 3 is p0+p1−p2−p3. The signal calculation for half shifted region 4 is −p2+p3. The signal calculation for half shifted region 5 is p0−p1−p2+p3. The signal calculation for half shifted region 6 is p0−p3. The signal calculation for half shifted region 7 is p0−p1+p2−p3. The signal calculation for half shifted region 8 is −p1+p3. The signal calculation for half shifted region 9 is −p0−p l+p2+p3. The signal calculation for half shifted region 10 is p2−p3. The signal calculation for half shifted region 11 is −p0+p1+p2−p3.

The upper half column 3206 indicates that any signal calculation from the signal column that returns a value greater than 0 is a set of pixel signals that corresponds to an upper half of the half shifted region. The lower half column 3208 indicates that any signal calculation from the signal column that returns a value less than 0 is a set of pixel signals that corresponds to a lower half of the half shifted region. In other words, after a half shifted region is determined by the region code, the calculation in the corresponding row in table 3200 determines whether the set of pixel signals corresponds to upper or lower half of the half shifted region.

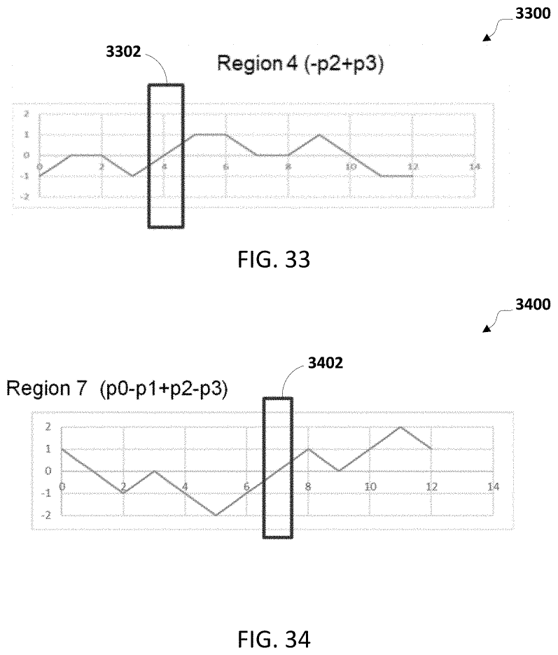

FIG. 33 is a chart illustrating a combined pixel signal 3300 from the first example calculations 3200 of FIG. 32 based on the plurality of ToF pixels 3100 of FIG. 31, in accordance with various aspects of the present disclosure. The horizontal axis of the graph corresponds to object distance. In the example of FIG. 33, the combined pixel signal 3300 is a subtraction of the pixel signal p2 from the pixel signal p3 (i.e. −p2+p3), which corresponds to half shifted region 4 in the first example calculations 3200.

As illustrated in FIG. 33, a highlighted section 3302 covers half shifted region 4. Within the highlighted section 3302, when the combined pixel signal 3300 is less than 0 would indicate the lower half of half shifted region 4 and greater than 0 would indicate the upper half of half shifted region 4.

FIG. 34 is a chart illustrating a second combined pixel signal 3400 from the first example calculations 3200 of FIG. 32 based on the plurality of ToF pixels 3100 of FIG. 31, in accordance with various aspects of the present disclosure. The horizontal axis of the graph corresponds to object distance. In the example of FIG. 34, the second combined pixel signal 3400 is the pixel signal p0 minus the pixel signal p1 plus the pixel signal p2 minus the pixel signal p3, which corresponds to half shifted region 7 in the first example calculations 3200.

As illustrated in FIG. 34, a highlighted section 3402 covers half shifted region 7. Within the highlighted section 3402, when the combined pixel signal 3400 is less than 0 would indicate the lower half of half shifted region 7 and greater than 0 would indicate the upper half of half shifted region 7.

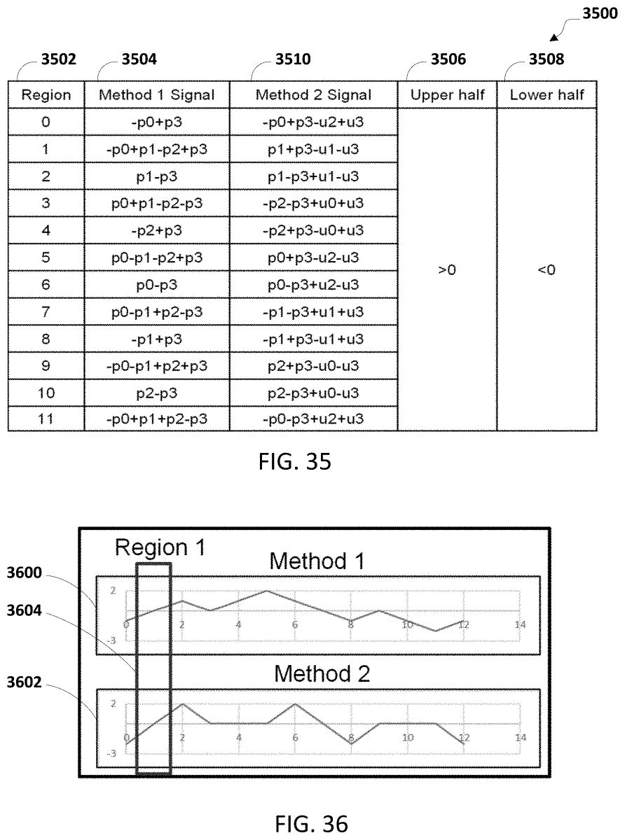

FIG. 35 is a table illustrating second example calculations 3500 to determine a lower half or a upper half in a half shifted region, in accordance with various aspects of the present disclosure. The table of second example calculations 3500 includes five columns: half shifted region column 3502, method 1 signal column 3504, upper half column 3506, lower half column 3508, and method 2 signal column 3510. The half shifted region column 3502, method 1 signal column 3504, upper half column 3506, lower half column 3508 correspond to the half shifted region column 3202, signal column 3204, upper half column 3206, and lower half column 3208 of FIG. 32. Consequently, description of these columns are not repeated herein.

The second example calculations 3500 differ from the first example calculation 3200 because the second example calculations 3500 include some of the ECC pixel signals in the method 2 signal column 3510.

The method 2 signal column 3510 includes a signal calculation to determine an upper half or a lower half of a particular half shifted region. The signal calculation for half shifted region 0 is −p0+p3−u2+u3. The signal calculation for half shifted region 1 is p1+p3−u1−u3. The signal calculation for half shifted region 2 is p1−p3+u1−u3. The signal calculation for half shifted region 3 is −p2−p3+u0+u3. The signal calculation for half shifted region 4 is −p2+p3−u0+u3. The signal calculation for half shifted region 5 is p0+p3−u2−u3. The signal calculation for half shifted region 6 is p0−p3+u2−u3. The signal calculation for half shifted region 7 is −p1−p3+u1+u3. The signal calculation for half shifted region 8 is −p1+p3-u1+u3. The signal calculation for half shifted region 9 is p2+p3−u0−u3. The signal calculation for half shifted region 10 is p2−p3+u0−u3. The signal calculation for half shifted region 11 is −p0−p3+u2+u3.

FIG. 36 is a chart illustrating first and second combined pixel signals 3600 and 3602 from the first example calculations 3504 of FIG. 35 and the second example calculations 3510 of FIG. 35, respectively, and based on the plurality of ToF pixel signals and ECC pixel signals of FIG. 29, in accordance with various aspects of the present disclosure. The horizontal axes of the graphs correspond to object distance.

In the example of FIG. 36, the ECC decoder has determined that the ToF pixel signals and ECC pixel signals correspond to half shifted region 1, and hence the signal calculations use the row corresponding to half shifted region 1. The first combined pixel signal 3600 is the pixel signal −p0 plus the pixel signal p1 minus the signal p2 plus the signal p3, which corresponds to the row of half shifted region 1 in column 3504 in the table 3500. Additionally, in the example of FIG. 36, the second combined pixel signal 3602 is the pixel signal p1 plus the pixel signal p3 minus the ECC pixel signal u1 minus the ECC pixel signal u3, which corresponds to the row of half shifted region 1 in column 3510 in the table 3500.

As illustrated in FIG. 36, a highlighted section 3604 covers region 1. Within the highlighted section 3604, when the combined pixel signals 3600 and 3602 having value less than 0 would indicate the lower half of half shifted region 1, and greater than 0 would indicate the upper half of half shifted region 1.

For comparison purposes, consider as a reference point that the signal, the noise, and the signal-to-noise ratio in the combined pixel signal 3600 is 1x. However, as illustrated in the half shifted region 1 area in the highlighted section 3604 in FIG. 36, the slope of the signal calculation result in 3602 is two times that of 3600, hence we refer to the signal calculation result 3602 as 2X. The noise in the combined pixel signal 3600 is the result of adding either two independent noise terms or adding four independent noise terms depending on the specific half shifted region (as shown in column 3504), whereas the noise in the combined pixel signal 3602 is the result of adding either two or four independent noise terms (as shown in column 3510). Hence the noise in 3510 (or equivalently 3602) is either 1X or the square root of 2X higher than the noise in 3504 (or equivalently 3600) depending on the half shifted region.

Combining the signal comparison and the noise comparison gives the signal-to-noise ratio in the combined pixel signal 3602 (or equivalently 3510) to be either 2X (i.e., 2X/1X) or the square root of 2X (i.e., 2X/2X) higher than the signal-to-noise ratio in the combined pixel signal 3600 (or equivalently 3504) depending on the half shifted region. In other words, the second example calculations 3510 provides more accurate result in the determination of the lower half or the upper half of the half shifted region relative to the first example calculations 3504 due to higher signal-to-noise ratio.

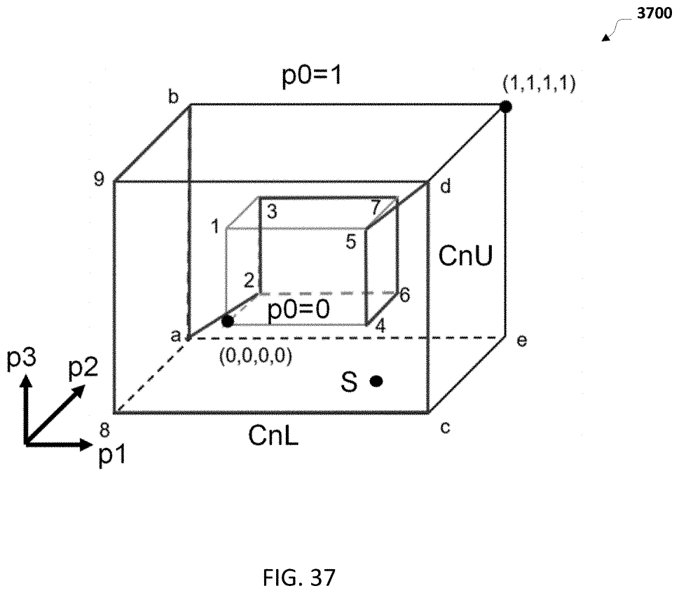

FIG. 37 is a diagram illustrating third example calculations 3700 to determine a lower half or an upper half in a half shifted region, in accordance with various aspects of the present disclosure.

Considering the gray4 ToF method as an example. As illustrated in FIG. 37, the pixel signals p0, p1, p2, and p3 may be represented by a 4-dimensional hypercube. The three arrows show the directions of the coordinates p1, p2 and p3. The outer cube corresponds to p0=1, and the inner cube corresponds to p0=0.

The red lines show the path of the ideal values (no noise) of the ToF pixels p0, p1, p2, and p3 in the ToF system. Each of the vertices (corners) of the hypercube corresponds to the value of a region code for the half shifted regions. Each red lined edge corresponds to a non-half shifted region.

As an example, consider a set of pixel values p0, p1, p2, and p3 which is represented by a point S in FIG. 37, the controller 2500 may determine the region code Rn for the half shifted region n. In this case the region code is c (or the bits 1100) which indicates half shifted region 8 (n=8) as shown in FIG. 16. Once n is known, the controller 2500 determines lower or upper half by determining which of the two red line candidates (referred to as “CnL” and “CnU”) joining the vertex Rn is a better choice. To do so, the controller 2500 may use a distance metric M to calculate the distances SL and SU between the point P and the two lines, respectively. The distance SL is equal to M(S,CnL) and the distance SU is equal M(S,CnU).

When the distance SL is smaller than the distance SU, then the controller 2500 determines the pixel values to correspond to the lower half. When the distance SU is smaller than the distance SL, then the controller 2500 determine the pixel values to correspond to the upper half. When the controller 2500 determines the distance SL and the distance SU are the same, then the controller 2500 may choose either the lower half or the upper half. In this determination, the controller 2500 may use any metric, e.g. L1 norm, L2 norm, etc.

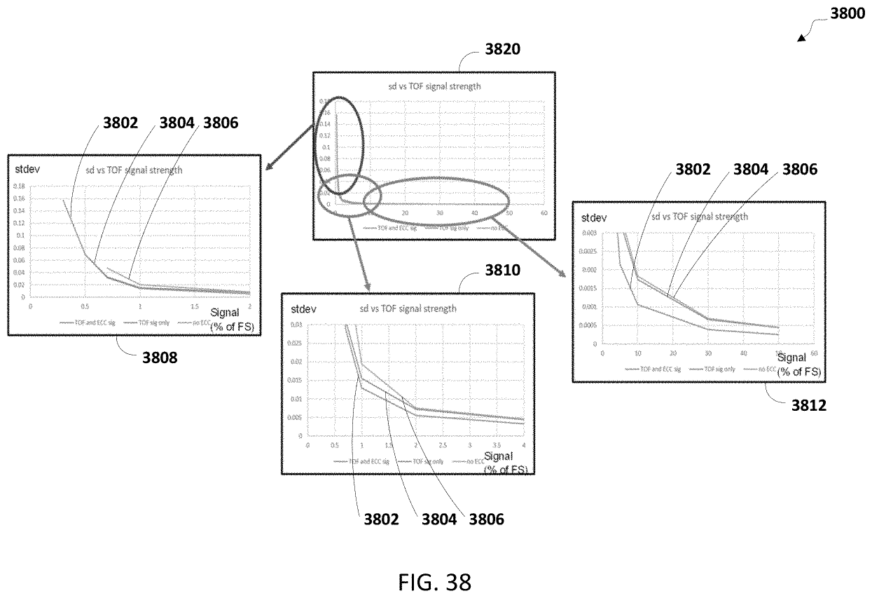

FIG. 38 is a diagram illustrating a comparison 3800 between the decoding method 3802 for ECC ToF shown in FIG. 30 (referred to as the “full ECC ToF decoding method”), the decoding method 3804 for ECC ToF where the steps 3006 and 3008 in FIG. 30 are skipped and the step 3010 uses the non-averaged pixel signals which is described in U.S. patent application Ser. No. 17/534,974 filed on Nov. 24,2021 (referred to as the “simple ECC ToF decoding method”), and the decoding method 3806 in a ToF system with no ECC(refer to as the “ToF only decoding”), in accordance with various aspects of the present disclosure. The comparison 3800 is broken into three different plots 3808-3812 for the sake of clarity. The three different plots 3808-3812 are each plots of standard deviation in calculated distance versus signal strength as a percentage of full signal level at different ranges of the signal strength. In other words, the plots 3808-3812 are zoomed in versions of the plot 3820.

The full ECC ToF decoding method (with performance 3802) uses both the ToF pixel signals p0, p1, p2, and p3 and the ECC pixel signals u0, u1, u2, and u3 with ECC results to determine an object distance as described above (e.g., FIG. 30). The simple ECC ToF decoding method (with performance 3804) uses both the ToF pixel signals p0, p1, p2, and p3 and the ECC pixel signals u0, u1, u2, and u3 to determine a region code and just the ToF pixel signals p0, p1, p2, and p3 with ECC results to determine an object distance (see descriptions above). The ToF only decoding method (with performance 3806) just uses the ToF pixel signals p0, p1, p2, and p3 without any ECC results to determine an object distance.

In the example of FIG. 38, at low signal strengths (plot 3808), the full ECC ToF decoding performance 3802 is about the same as the simple ECC ToF decoding performance 3804 because quantization noise is larger than pixel noise. Hence, quantization noise dominates and signal averaging does not substantially impact quantization noise. Both the full ECC ToF decoding performance 3802 and the simple ECC ToF decoding performance 3804 are better than the ToF only decoding (no ECC) performance 3806 at low signal strengths.

In the example of FIG. 38, at mid-range signal strengths (plot 3810), the simple ECC ToF decoding performance 3804 moves away from the performance of the full ECC ToF decoding performance 3802 towards the performance of the no ECC performance 3806. In other words, the full ECC ToF decoding performance 3802 is the best, followed by the simple ECC ToF decoding performance 3804, whereas the ToF only decoding performance 3806 is the lowest.

In the example of FIG. 38, at high signal strengths (plot 3812), the simple ECC ToF decoding performance 3804 is about the same as the ToF only decoding performance 3806 because the probability of bit error in the region code is low. Hence, ECC does not significantly impact the performance at high signal strengths. The full ECC ToF decoding performance 3802 is better than both the simple ECC ToF decoding performance 3804 and the ToF only decoding performance 3806 at high signal strengths.

Considering the entirety of signal levels as a whole in view of FIG. 38, the full ECC ToF decoding performance 3802 is best overall, the simple ECC ToF decoding performance 3804 is second and the ToF only decoding performance 3802 is third.

### [Conclusion]

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Accordingly, it is to be understood that the above description is intended to be illustrative and not restrictive. Many examples and applications other than the examples provided would be apparent upon reading the above description. The scope should be determined, not with reference to the above description, but should instead be determined with reference to the appended claims, along with the full scope of equivalents to which the claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A Time-of-Flight (ToF) sensor comprising:
an array of pixels; and
processing circuitry configured to
generate a plurality of ToF exposure control signals that control at least one pixel of the array of pixels to generate a plurality of ToF pixel signals,
generate a plurality of error correcting code (ECC) exposure control signals that control the at least one pixel to generate a plurality of ECC pixel signals, and
determine a distance from an object based on the plurality of ToF pixel signals and the plurality of ECC pixel signals,
wherein, to determine the distance from the object based on the plurality of ToF pixel signals and the plurality of ECC pixel signals, the processing circuitry is further configured to
determine a region code from the plurality of ToF pixel signals and the plurality of ECC pixel signals, and
calculate the distance based on the plurality of ToF pixel signals, the plurality of ECC pixel signals, and the region code.

2. The ToF sensor according to claim 1, wherein the region code is a half shifted region code.

3. The ToF sensor according to claim 2, wherein, to calculate the distance based on the plurality of ToF pixel signals, the plurality of ECC pixel signals, and the region code, the processing circuitry is further configured to
determine whether a pixel signal corresponds to a lower half or an upper half of a half shifted region represented by the half shifted region code, the pixel signal based on two or more of the plurality of ToF pixel signals or a combination from the plurality of ToF pixel signals and the plurality of ECC pixel signals,
average the plurality of ToF pixel signals with the plurality of ECC pixel signals using information from the lower half or the upper half of the half shifted region that is determined to generate a plurality of average pixel signals, and
calculate the distance based on the plurality of average pixel signals.

4. The ToF sensor according to claim 1, wherein the ECC bits are Ham4 ECC bits, and wherein, to determine the region code from the plurality of threshold bits with the ECC bits, the processing circuitry is further configured to perform ECC decoding with the Ham4 ECC bits to detect and correct a bit error in the plurality of threshold bits.

5. The ToF sensor according to claim 1, wherein the ECC bits are Gray4 ECC bits, and wherein, to determine the region code from the plurality of threshold bits with the ECC bits, the processing circuitry is further configured perform ECC decoding with the Gray4 ECC bits to detect and correct a bit error in the plurality of threshold bits.

6. The ToF sensor according to claim 1, wherein, to perform ECC decoding with the ToF bits and the ECC bits to detect and correct a bit error in the plurality of threshold bits, the processing circuitry is further configured to
determine a syndrome,
determine whether the syndrome is all zeroes,
determine that the bit error does not exist in the plurality of threshold bits in response to determining that the syndrome is all zeroes.

7. The ToF sensor according to claim 6, wherein, to perform ECC decoding with the ToF bits and the ECC bits to detect and correct a bit error in the plurality of threshold bits, the processing circuitry is further configured to
determine whether the syndrome matches one column in a matrix in response to determining that the syndrome is not all zeroes, and
detect the bit error in the plurality of threshold bits in response to determining that the syndrome matches the one column in the matrix, the one column being associated with one threshold bit in the plurality of threshold bits, and wherein the one threshold bit is the bit error.

8. The ToF sensor according to claim 1, wherein the processing circuitry is further configured to
detect two or more bit errors in the plurality of threshold bits, and
declare the at least one pixel as an invalid pixel in response to detecting the two or more bit errors in the plurality of threshold bits.

9. A method comprising:
generating, with processing circuitry, a plurality of ToF exposure control signals that control at least one pixel of an array of pixels to generate a plurality of ToF pixel signals;
generating, with the processing circuitry, a plurality of error correcting code (ECC) exposure control signals that control the at least one pixel to generate a plurality of ECC pixel signals; and
determining, with the processing circuitry, a distance from an object based on the plurality of ToF pixel signals and the plurality of ECC pixel signals by
determining a region code from the plurality of ToF pixel signals and the plurality of ECC pixel signals, and
calculating the distance based on the plurality of ToF pixel signals, the plurality of ECC pixel signals, and the region code.

10. The method according to claim 9, wherein the region code is a half shifted region code.

11. The method according to claim 10, wherein calculating the distance based on the plurality of ToF pixel signals, the plurality of ECC pixel signals, and the region code, further includes
determining whether a pixel signal corresponds to a lower half or an upper half of the half shifted region represented by the half shifted region code, the pixel signal based on two or more of the plurality of ToF pixel signals or a combination from the plurality of ToF pixel signals and the plurality of ECC pixel signals,
averaging the plurality of ToF pixel signals with the plurality of ECC pixel signals using information from the lower half or the upper half of the half shifted region that is determined to generate a plurality of average pixel signals, and
calculating the distance based on the plurality of average pixel signals.

12. The method according to claim 9, wherein the ECC bits are Ham4 ECC bits, and wherein determining the region code from the plurality of threshold bits with the ECC bits further includes performing ECC decoding with the Ham4 ECC bits to detect and correct a bit error in the plurality of threshold bits.

13. The method according to claim 9, wherein the ECC bits are Gray4 ECC bits, and wherein determining the region code from the plurality of threshold bits with the ECC bits further includes performing ECC decoding with the Gray4 ECC bits to detect and correct a bit error in the plurality of threshold bits.

14. The method according to claim 9, wherein performing ECC decoding with the ToF bits and the ECC bits to detect and correct a bit error in the plurality of threshold bits further includes
determining a syndrome,
determining whether the syndrome is all zeroes, and
determining that the bit error does not exist in the plurality of threshold bits in response to determining that the syndrome is all zeroes.

15. The method according to claim 14, wherein performing ECC decoding with the ToF bits and the ECC bits to detect and correct a bit error in the plurality of threshold bits further includes
determining whether the syndrome matches one column in a matrix in response to determining that the syndrome is not all zeroes, and
detecting the bit error in the plurality of threshold bits in response to determining that the syndrome matches the one column in the matrix, the one column being associated with one threshold bit in the plurality of threshold bits, and wherein the one threshold bit is the bit error.

16. The method according to claim 9, further comprising:
detecting two or more bit errors in the plurality of threshold bits; and
declaring the at least one pixel as an invalid pixel in response to detecting the two or more bit errors in the plurality of threshold bits.

17. A non-transitory computer-readable medium comprising instructions that, when executed by an electronic processor, cause the electronic processor to perform a set of operations comprising:
generating a plurality of ToF exposure control signals that control at least one pixel of an array of pixels to generate a plurality of ToF pixel signals,
generating a plurality of error correcting code (ECC) exposure control signals that control the at least one pixel to generate a plurality of ECC pixel signals; and
determining a distance from an object based on the plurality of ToF pixel signals and the plurality of ECC pixel signals by
determining a region code from the plurality of ToF pixel signals and the plurality of ECC pixel signals, and
calculating the distance based on the plurality of ToF pixel signals, the plurality of ECC pixel signals, and the region code.

18. The non-transitory computer-readable medium according to claim 17, wherein the region code is a half shifted region code.

19. The non-transitory computer-readable medium according to claim 18, wherein calculating the distance based on the plurality of ToF pixel signals, the plurality of ECC pixel signals, and the region code, further includes
determining whether a pixel signal corresponds to a lower half or an upper half of the half shifted region represented by the half shifted region code, the pixel signal based on two or more of the plurality of ToF pixel signals or a combination from the plurality of ToF pixel signals and the plurality of ECC pixel signals,
averaging the plurality of ToF pixel signals with the plurality of ECC pixel signals using information from the lower half or the upper half of the half shifted region that is determined to generate a plurality of average pixel signals, and
calculating the distance based on the plurality of average pixel signals.

20. The non-transitory computer-readable medium according to claim 17, wherein the ECC bits are Ham4 ECC bits, and wherein determining the region code from the plurality of threshold bits with the ECC bits further includes performing ECC decoding with the Ham4 ECC bits to detect and correct a bit error in the plurality of threshold bits.
